(19) United States
(12) Patent Application Publication
(10) Pub. No.: US 2021/0390080 A1
(43) Pub. Date: Dec. 16, 2021

(54) ACTIONS BASED ON FILE TAGGING IN A DISTRIBUTED FILE SERVER VIRTUAL MACHINE (FSVM) ENVIRONMENT

(71) Applicant: Nutanix, Inc., San Jose, CA (US)

(72) Inventors: DEEPAK TRIPATHI, SAN JOSE, CA (US); KALPESH ASHOK BAFNA, MILPITAS, CA (US); PARTHA PRATIM NAYAK, SAN JOSE, CA (US); SHYAMSUNDER PRAYAGCHAND RATHI, SUNNYVALE, CA (US)

(73) Assignee: Nutanix, Inc., San Jose, CA (US)

(21) Appl. No.: 16/944,323

(22) Filed: Jul. 31, 2020

Related U.S. Application Data
(60) Provisional application No. 63/039,057, filed on Jun. 15, 2020.

(51) Int. Cl. G06F 16/16; G06F 16/182; G06F 16/188

(52) U.S. Cl. CPC G06F 16/164; G06F 16/188; G06F 16/182

(57) ABSTRACT

An example system includes a plurality of FSVMs executing at two or more computing nodes configured to cooperatively manage a distributed VFS and a system manager configured to provide a tag based on a pattern and an action associated with the tag to the plurality of FSVMs. The plurality of FSVMs are further configured to scan files of the VFS to tag files including the pattern and tag and to take the action with respect to files in the VFS having the tag.

### CROSS-REFERENCE TO RELATED APPLICATIONS

This application claims priority to Provisional Application No. 63/039,057 filed Jun. 22, 2020. The aforementioned application is incorporated herein by reference, in its entirety, for any purpose.

### BACKGROUND

Data stored on file servers often includes sensitive data, data pertaining to particular sensitive projects, and data subject to different replication policies due to the nature of the data. Access and replication policies may be implemented by storing all files containing the same type of sensitive information in the same directory, folder, or location, and controlling access to, and replication of, that directory, folder, or location. Accordingly, replication may be inefficient and it may be difficult to replicate groups of storage items that are located in different folders or shares.

### SUMMARY

Example non-transitory computer readable media are disclosed herein. Example non-transitory computer readable media are encoded with instructions which, when executed by one or more processors of a computing node, cause the computing node to provide a file server virtual machine (FSVM) configured to participate in a cluster of FSVMs configured to cooperatively manage a distributed virtualized file system (VFS) and to take a specified action on a file stored on a volume group managed by the FSVM, where the file includes a tag indicative of a pattern included in the file.

Example systems are disclosed herein. An example system includes a plurality of FSVMs executing at two or more computing nodes configured to cooperatively manage a distributed VFS and a system manager configured to provide a tag based on a pattern and an action associated with the tag to the plurality of FSVMs. The plurality of FSVMs are further configured to scan files of the VFS to tag files including the pattern and tag and to take the action with respect to files in the VFS having the tag.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a clustered virtualization environment 100 according to particular embodiments.

FIG. 2 illustrates data flow within a clustered virtualization environment 200 according to particular embodiments.

FIG. 3 illustrates a clustered virtualization environment 300 implementing a virtualized file server according to particular embodiments.

FIG. 4 illustrates a clustered virtualization environment 400 implementing a virtualized file server in which files used by user VMs are stored locally on the same host machines as the user VMs according to particular embodiments.

FIG. 5 illustrates an example hierarchical structure of a VFS instance in a cluster according to particular embodiments.

FIG. 6 illustrates two example host machines, each providing file storage services for portions of two VFS instances FS1 and FS2 according to particular embodiments.

FIG. 7 illustrates example interactions between a client and host machines on which different portions of a VFS instance are stored according to particular embodiments.

FIG. 8 illustrates an example virtualized file server having a failover capability according to particular embodiments.

FIG. 9 illustrates an example virtualized file server that has recovered from a failure of a controller/service VM by switching to an alternate controller/service VM according to particular embodiments.

FIG. 10 illustrates an example virtualized file server that has recovered from failure of a file server VM by electing a new leader file server VM according to particular embodiments.

FIG. 11 illustrates an example failure of a host machine that causes failure of both the file server VM and the controller/service VM located on the host machine according to particular embodiments.

FIG. 12 illustrates an example virtualized file server that has recovered from a host machine failure by switching to a controller/service VM and a file server VM located on a backup host machine according to particular embodiments.

FIG. 13 illustrates an example hierarchical namespace of a file server according to particular embodiments.

FIG. 14 illustrates an example hierarchical namespace of a file server according to particular embodiments.

FIG. 15 illustrates distribution of stored data amongst host machines in a virtualized file server according to particular embodiments.

FIG. 16 illustrates an example virtualized file system (VFS) environment in which a VFS is deployed across multiple clusters according to particular embodiments.

FIG. 17A illustrates an example VFS environment in accordance with one embodiment.

FIG. 17B illustrates an example VFS environment in accordance with one embodiment.

FIG. 18 illustrates an example method for tagging files in a virtualized file server in accordance with one embodiment.

FIG. 19 illustrates a block diagram of an illustrative computing system 1900 suitable for implementing particular embodiments.

### DETAILED DESCRIPTION

Embodiments presented herein disclose tagging and executions of actions based on tags within a distributed virtualized file system (VFS) environment. Tags may be applied to files in the VFS based on pre-defined or user defined patterns, such as specific words appearing in a file (e.g., a sensitive marker or a project name), a pattern appearing in a file (e.g., a number formatted as a social security number), files containing information about a particular subject, or formatting of files (e.g., spreadsheets of customer information). Individual file server virtual machines (FSVMs) managing portions of the VFS may scan files managed by the FSVM to look for patterns, tag files including the patterns, and take action with regards to tagged files. Accordingly, even files stored in different directories, volume groups, or folders of a VFS may be subject to the same data control policies, such as by basing the data control policies or other actions based on tag. Further, a system manager for the VFS may provide an administrative user to view statistics regarding tagged files on the VFS.

One reason for the broad adoption of virtualization in modern business and computing environments is because of the resource utilization advantages provided by virtual machines. Without virtualization, if a physical machine is limited to a single dedicated operating system, then during periods of inactivity by the dedicated operating system the physical machine is not utilized to perform useful work. This is wasteful and inefficient if there are users on other physical machines which are currently waiting for computing resources. To address this problem, virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

Furthermore, there are now products that can aggregate multiple physical machines, running virtualization environments to not only utilize the processing power of the physical devices to aggregate the storage of the individual physical devices to create a logical storage pool wherein the data may be distributed across the physical devices but appears to the virtual machines to be part of the system that the virtual machine is hosted on. Such systems operate under the covers by using metadata, which may be distributed and replicated any number of times across the system, to locate the indicated data. These systems are commonly referred to as clustered systems, wherein the resources of the group are pooled to provide logically combined, but physically separate systems.

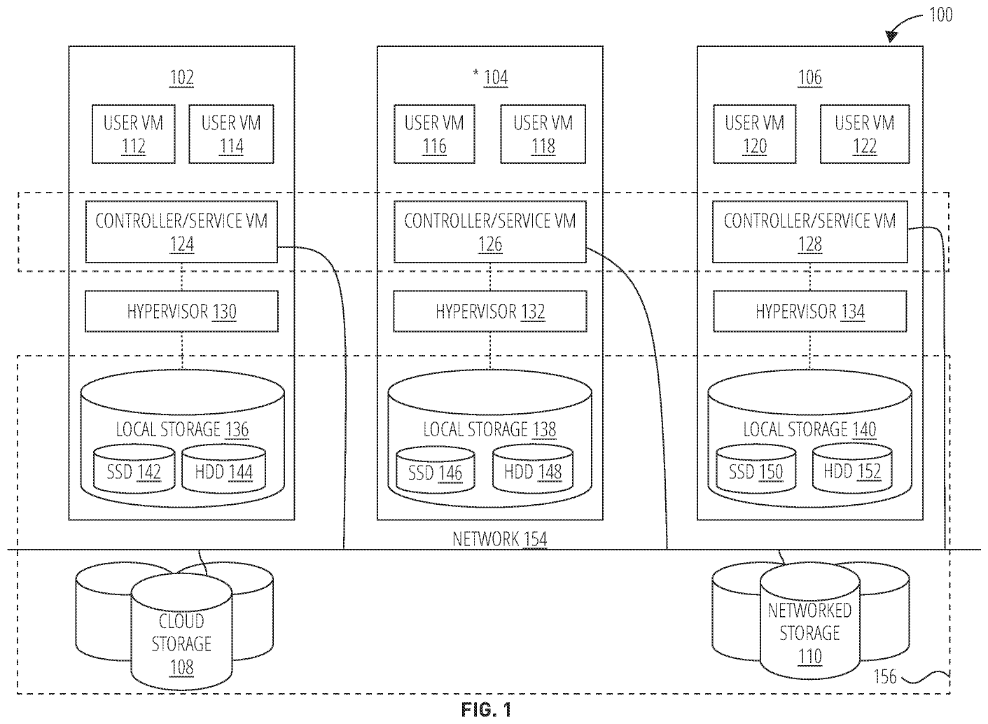

FIG. 1 illustrates a clustered virtualization environment 100 according to particular embodiments. The architectures of FIG. 1 can be implemented for a distributed platform that contains multiple host machines 102, 106, and 104 that manage multiple tiers of storage. The multiple tiers of storage may include storage that is accessible through network 154, such as, by way of example and not limitation, cloud storage 108 (e.g., which may be accessible through the Internet), network-attached storage 110 (NAS) (e.g., which may be accessible through a LAN), or a storage area network (SAN). Unlike the prior art, the present embodiment also permits 136, 138, and 140 that is incorporated into or directly attached to the host machine and/or appliance to be managed as part of storage pool 156. Examples of such local storage include Solid State Drives 142, 146, and 150 (henceforth “SSDs”), Hard Disk Drives 144, 148, and 152 (henceforth “HDDs” or “spindle drives”), optical disk drives, external drives (e.g., a storage device connected to a host machine via a native drive interface or a serial attached SCSI interface), or any other direct-attached storage. These storage devices, both direct-attached and network-accessible, collectively form storage pool 156. Virtual disks (or “vDisks”) may be structured from the physical storage devices in storage pool 156, as described in more detail below. As used herein, the term vDisk refers to the storage abstraction that is exposed by a Controller/Service VM (CVM) (e.g., 124) to be used by a user VM (e.g., 112). In particular embodiments, the vDisk may be exposed via iSCSI (“internet small computer system interface”) or NFS (“network filesystem”) and is mounted as a virtual disk on the user VM. In particular embodiments, vDisks may be organized into one or more volume groups (VGs).

Each host machine 102, 106, 104 may run virtualization software, such as VMWARE ESX(I), MICROSOFT HYPER-V, or REDHAT KVM. The virtualization software includes 130, 132, and 134 to create, manage, and destroy user VMs, as well as managing the interactions between the underlying hardware and user VMs. User VMs may run one or more applications that may operate as “clients” with respect to other elements within clustered virtualization environment 100. Though not depicted in FIG. 1, a hypervisor may connect to network 154. In particular embodiments, a host machine 102, 106, or 104 may be a physical hardware computing device; in particular embodiments, a host machine 102, 106, or 104 may be a virtual machine.

CVMs 124, 126, and 128 are used to manage storage and input/output (“I/O”) activities according to particular embodiments. These special VMs act as the storage controller in the currently described architecture. Multiple such storage controllers may coordinate within a cluster to form a unified storage controller system. CVMs may run as virtual machines on the various host machines, and work together to form a distributed system that manages all the storage resources, including local storage, network-attached storage 110, and cloud storage 108. The CVMs may connect to network 154 directly, or via a hypervisor. Since the CVMs run independent of hypervisors 130, 132, 134, this means that the current approach can be used and implemented within any virtual machine architecture, since the CVMs of particular embodiments can be used in conjunction with any hypervisor from any virtualization vendor.

A host machine may be designated as a leader node within a cluster of host machines. For example, host machine 104, as indicated by the asterisks, may be a leader node. A leader node may have a software component designated to perform operations of the leader. For example, CVM 126 on host machine 104 may be designated to perform such operations. A leader may be responsible for monitoring or handling requests from other host machines or software components on other host machines throughout the virtualized environment. If a leader fails, a new leader may be designated. In particular embodiments, a management module (e.g., in the form of an agent) may be running on the leader node.

Each CVM 124, 126, and 128 exports one or more block devices or NFS server targets that appear as disks to user VMs 112, 114, 116, 118, 120, and 122. These disks are virtual, since they are implemented by the software running inside CVMs 124, 126, and 128. Thus, to user VMs, CVMs appear to be exporting a clustered storage appliance that contains some disks. All user data (including the operating system) in the user VMs reside on these virtual disks.

Significant performance advantages can be gained by allowing the virtualization system to access and utilize local storage 136, 138, and 140 as disclosed herein. This is because I/O performance is typically much faster when performing access to local storage as compared to performing access to network-attached storage 110 across a network 154. This faster performance for locally attached storage can be increased even further by using certain types of optimized local storage devices, such as SSDs. Further details regarding methods and mechanisms for implementing the virtualization environment illustrated in FIG. 1 are described in U.S. Pat. No. 8,601,473, which is hereby incorporated by reference in its entirety.

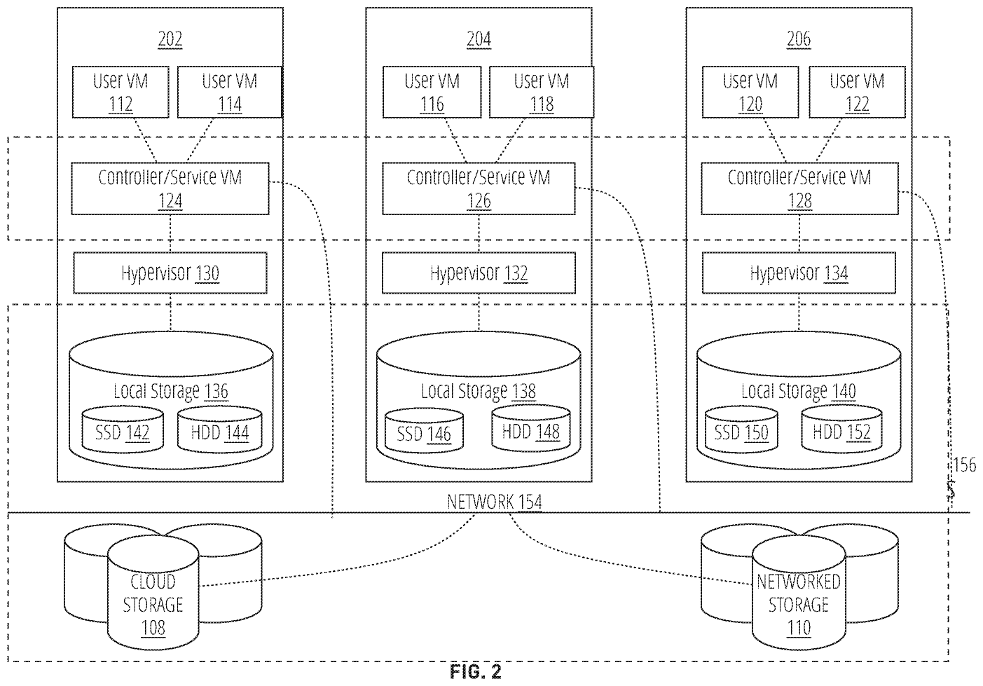

FIG. 2 illustrates data flow within an example clustered virtualization environment 100 according to particular embodiments. As described above, one or more user VMs and a CVM may run on each host machine 202, 204, or 206 along with a hypervisor. As a user VM performs I/O operations (e.g., a read operation or a write operation), the I/O commands of the user VM may be sent to the hypervisor that shares the same server as the user VM. For example, the hypervisor may present to the virtual machines an emulated storage controller, receive an I/O command and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 156. Additionally or alternatively, CVMs 124, 126, 128 may present an emulated storage controller either to the hypervisor or to user VMs to facilitate I/O operations. CVMs 124, 126, and 128 may be connected to storage within storage pool 156. CVM 124 may have the ability to perform I/O operations using 136 within the same host machine 202, by connecting via network 154 to cloud storage 108 or network-attached storage 110, or by connecting via network 154 to 138 or 140 within another host machine 204 or 206 (e.g., via connecting to another CVM 126 or 128). In particular embodiments, any suitable computing system may be used to implement a host machine.

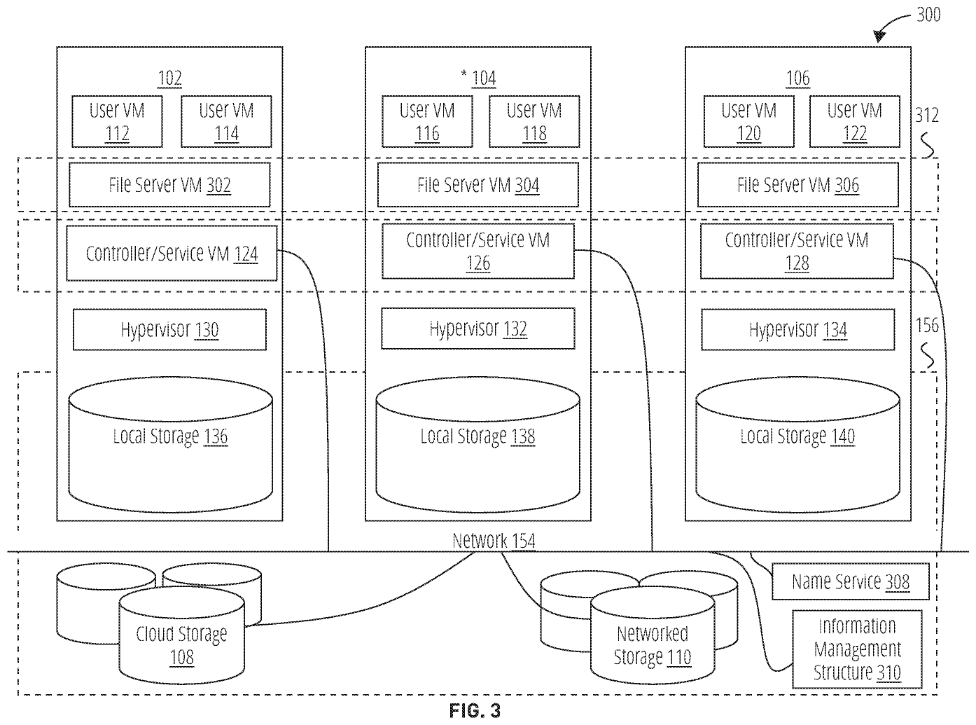

FIG. 3 illustrates a clustered virtualization environment 300 implementing a virtualized file server (VFS) 358 according to particular embodiments. In particular embodiments, the VFS 312 provides file services to user VMs 112, 114, 116, 118, 120, and 122. The file services may include storing and retrieving data persistently, reliably, and efficiently. The user virtual machines may execute user processes, such as office applications or the like, on host machines 102, 202, and 106. The stored data may be represented as a set of storage items, such as files organized in a hierarchical structure of folders (also known as directories), which can contain files and other folders, and shares, which can also contain files and folders.

In particular embodiments, the VFS 312 may include a set of File Server Virtual Machines (FSVMs) 302, 304, and 306 that execute on host machines 102, 202, and 106 and process storage item access operations requested by user VMs executing on the host machines 102, 202, and 106. The FSVMs 302, 304, and 306 may communicate with storage controllers provided by CVMs 124, 132, 128 executing on the host machines 102, 202, 106 to store and retrieve files, folders, SMB shares, or other storage items on 136, 340, 342 associated with, e.g., local to, the host machines 102, 202, 106. The FSVMs 326, 328, 330 may store and retrieve block-level data on the host machines 102, 202, 106, e.g., on the 136, 138, 140 of the host machines 102, 202, 106. The block-level data may include block-level representations of the storage items. The network protocol used for communication between user VMs, FSVMs, and CVMs via the network 154 may be Internet Small Computer Systems Interface (iSCSI), Server Message Block (SMB), Network Filesystem (NFS), pNFS (Parallel NFS), or another appropriate protocol.

For the purposes of VFS 312, host machine 106 may be designated as a leader node within a cluster of host machines. In this case, FSVM 306 on host machine 106 may be designated to perform such operations. A leader may be responsible for monitoring or handling requests from FSVMs on other host machines throughout the virtualized environment. If FSVM 306 fails, a new leader may be designated for VFS 312.

In particular embodiments, the user VMs may send data to the VFS 312 using write requests, and may receive data from it using read requests. The read and write requests, and their associated parameters, data, and results, may be sent between a user VM and one or more file server VMs (FSVMs) located on the same host machine as the user VM or on different host machines from the user VM. The read and write requests may be sent between host machines 102, 202, 106 via network 154, e.g., using a network communication protocol such as iSCSI, CIFS, SMB, TCP, IP, or the like. When a read or write request is sent between two VMs located on the same one of the host machines 102, 202, 106 (e.g., between the 112 and the FSVM 302 located on the host machine 102), the request may be sent using local communication within the host machine 102 instead of via the network 154. As described above, such local communication may be substantially faster than communication via the network 154. The local communication may be performed by, e.g., writing to and reading from shared memory accessible by the 112 and the FSVM 302, sending and receiving data via a local “loopback” network interface, local stream communication, or the like.

In particular embodiments, the storage items stored by the VFS 312, such as files and folders, may be distributed amongst multiple FSVMs 302, 304, 306. In particular embodiments, when storage access requests are received from the user VMs, the VFS 312 identifies FSVMs 302, 304, 306 at which requested storage items, e.g., folders, files, or portions thereof, are stored, and directs the user VMs to the locations of the storage items. The FSVMs 302, 304, 306 may maintain a storage map, such as a sharding map, that maps names or identifiers of storage items to their corresponding locations. The storage map may be a distributed data structure of which copies are maintained at each FSVM 302, 304, 306 and accessed using distributed locks or other storage item access operations. Alternatively, the storage map may be maintained by an FSVM at a leader node such as the FSVM 306, and the other FSVMs 302 and 304 may send requests to query and update the storage map to the leader FSVM 306. Other implementations of the storage map are possible using appropriate techniques to provide asynchronous data access to a shared resource by multiple readers and writers. The storage map may map names or identifiers of storage items in the form of text strings or numeric identifiers, such as folder names, files names, and/or identifiers of portions of folders or files (e.g., numeric start offset positions and counts in bytes or other units) to locations of the files, folders, or portions thereof. Locations may be represented as names of FSVMs, e.g., “FSVM-1”, as network addresses of host machines on which FSVMs are located (e.g., “ip-addr1” or 128.1.1.10), or as other types of location identifiers.

When a user application executing in a 112 on one of the host machines 102 initiates a storage access operation, such as reading or writing data, the 112 may send the storage access operation in a request to one of the FSVMs 302, 304, 306 on one of the host machines 102, 202, 106. A FSVM 304 executing on a host machine 202 that receives a storage access request may use the storage map to determine whether the requested file or folder is located on the FSVM 304. If the requested file or folder is located on the FSVM 304, the FSVM 304 executes the requested storage access operation. Otherwise, the FSVM 304 responds to the request with an indication that the data is not on the FSVM 304, and may redirect the requesting 112 to the FSVM on which the storage map indicates the file or folder is located. The client may cache the address of the FSVM on which the file or folder is located, so that it may send subsequent requests for the file or folder directly to that FSVM.

As an example and not by way of limitation, the location of a file or a folder may be pinned to a particular FSVM 302 by sending a file service operation that creates the file or folder to a CVM 124 associated with (e.g., located on the same host machine as) the FSVM 302. The CVM 124 subsequently processes file service commands for that file for the FSVM 302 and sends corresponding storage access operations to storage devices associated with the file. The CVM 124 may associate 136 with the file if there is sufficient free space on 136. Alternatively, the CVM 124 may associate a storage device located on another host machine 202, e.g., in 138, with the file under certain conditions, e.g., if there is insufficient free space on the 136, or if storage access operations between the CVM 124 and the file are expected to be infrequent. Files and folders, or portions thereof, may also be stored on other storage devices, such as the network-attached storage (NAS) network-attached storage 110 or the cloud storage 108 of the storage pool 156.

In particular embodiments, a name service 308, such as that specified by the Domain Name System (DNS) Internet protocol, may communicate with the host machines 102, 202, 106 via the network 154 and may store a database of domain name (e.g., host name) to IP address mappings. The domain names may correspond to FSVMs, e.g., fsvm1.domain.com or ip-addr1.domain.com for an FSVM named FSVM-1. The name service 308 may be queried by the user VMs to determine the IP address of a particular host machine 102, 202, 106 given a name of the host machine, e.g., to determine the IP address of the host name ip-addr1 for the host machine 102. The name service 308 may be located on a separate server computer system or on one or more of the host machines 102, 202, 106. The names and IP addresses of the host machines of the VFS 312, e.g., the host machines 102, 202, 106, may be stored in the name service 308 so that the user VMs may determine the IP address of each of the host machines 102, 202, 106, or FSVMs 302, 304, 306. The name of each VFS instance, e.g., FS1, FS2, or the like, may be stored in the name service 308 in association with a set of one or more names that contains the name(s) of the host machines 102, 202, 106 or FSVMs 302, 304, 306 of the VFS instance VFS 312. The FSVMs 302, 304, 306 may be associated with the host names ip-addr1, ip-addr2, and ip-addr3, respectively. For example, the file server instance name FS1.domain.com may be associated with the host names ip-addr1, ip-addr2, and ip-addr3 in the name service 308, so that a query of the name service 308 for the server instance name “FS1” or “FS1.domain.com” returns the names ip-addr1, ip-addr2, and ip-addr3. As another example, the file server instance name FS1.domain.com may be associated with the host names fsvm-1, fsvm-2, and fsvm-3. Further, the name service 308 may return the names in a different order for each name lookup request, e.g., using round-robin ordering, so that the sequence of names (or addresses) returned by the name service for a file server instance name is a different permutation for each query until all the permutations have been returned in response to requests, at which point the permutation cycle starts again, e.g., with the first permutation. In this way, storage access requests from user VMs may be balanced across the host machines, since the user VMs submit requests to the name service 308 for the address of the VFS instance for storage items for which the user VMs do not have a record or cache entry, as described below.

In particular embodiments, each FSVM may have two IP addresses: an external IP address and an internal IP address. The external IP addresses may be used by SMB/CIFS clients, such as user VMs, to connect to the FSVMs. The external IP addresses may be stored in the name service 308. The IP addresses ip-addr1, ip-addr2, and ip-addr3 described above are examples of external IP addresses. The internal IP addresses may be used for iSCSI communication to CVMs, e.g., between the FSVMs 302, 304, 306 and the CVMs 124, 132, 128. Other internal communications may be sent via the internal IP addresses as well, e.g., file server configuration information may be sent from the CVMs to the FSVMs using the internal IP addresses, and the CVMs may get file server statistics from the FSVMs via internal communication as needed.

Since the VFS 312 is provided by a distributed set of FSVMs 302, 304, 306, the user VMs that access particular requested storage items, such as files or folders, do not necessarily know the locations of the requested storage items when the request is received. A distributed file system protocol, e.g., MICROSOFT DFS or the like, is therefore used, in which a user VM 112 may request the addresses of FSVMs 302, 304, 306 from a name service 308 (e.g., DNS). The name service 308 may send one or more network addresses of FSVMs 302, 304, 306 to the user VM 112, in an order that changes for each subsequent request. These network addresses are not necessarily the addresses of the FSVM 304 on which the storage item requested by the user VM 112 is located, since the name service 308 does not necessarily have information about the mapping between storage items and FSVMs 302, 304, 306. Next, the user VM 112 may send an access request to one of the network addresses provided by the name service, e.g., the address of FSVM 304. The FSVM 304 may receive the access request and determine whether the storage item identified by the request is located on the FSVM 304. If so, the FSVM 304 may process the request and send the results to the requesting user VM 112. However, if the identified storage item is located on a different FSVM 306, then the FSVM 304 may redirect the user VM 112 to the FSVM 306 on which the requested storage item is located by sending a “redirect” response referencing FSVM 306 to the user VM 112. The user VM 112 may then send the access request to FSVM 306, which may perform the requested operation for the identified storage item.

A particular VFS 312, including the items it stores, e.g., files and folders, may be referred to herein as a VFS “instance” and may have an associated name, e.g., FS1, as described above. Although a VFS instance may have multiple FSVMs distributed across different host machines, with different files being stored on FSVMs, the VFS instance may present a single name space to its clients such as the user VMs. The single name space may include, for example, a set of named “shares” and each share may have an associated folder hierarchy in which files are stored. Storage items such as files and folders may have associated names and metadata such as permissions, access control information, size quota limits, file types, files sizes, and so on. As another example, the name space may be a single folder hierarchy, e.g., a single root directory that contains files and other folders. User VMs may access the data stored on a distributed VFS instance via storage access operations, such as operations to list folders and files in a specified folder, create a new file or folder, open an existing file for reading or writing, and read data from or write data to a file, as well as storage item manipulation operations to rename, delete, copy, or get details, such as metadata, of files or folders. Note that folders may also be referred to herein as “directories.”

In particular embodiments, storage items such as files and folders in a file server namespace may be accessed by clients such as user VMs by name, e.g., “\Folder-1\File-1” and “\Folder-2\File-2” for two different files named File-1 and File-2 in the folders Folder-1 and Folder-2, respectively (where Folder-1 and Folder-2 are sub-folders of the root folder). Names that identify files in the namespace using folder names and file names may be referred to as “path names.” Client systems may access the storage items stored on the VFS instance by specifying the file names or path names, e.g., the path name “\Folder-1\File-1”, in storage access operations. If the storage items are stored on a share (e.g., a shared drive), then the share name may be used to access the storage items, e.g., via the path name “\\Share-1\Folder-1\File-1” to access File-1 in folder Folder-1 on a share named Share-1.

In particular embodiments, although the VFS instance may store different folders, files, or portions thereof at different locations, e.g., on different FSVMs, the use of different FSVMs or other elements of storage pool 156 to store the folders and files may be hidden from the accessing clients. The share name is not necessarily a name of a location such as an FSVM or host machine. For example, the name Share-1 does not identify a particular FSVM on which storage items of the share are located. The share Share-1 may have portions of storage items stored on three host machines, but a user may simply access Share-1, e.g., by mapping Share-1 to a client computer, to gain access to the storage items on Share-1 as if they were located on the client computer. Names of storage items, such as file names and folder names, are similarly location-independent. Thus, although storage items, such as files and their containing folders and shares, may be stored at different locations, such as different host machines, the files may be accessed in a location-transparent manner by clients (such as the user VMs). Thus, users at client systems need not specify or know the locations of each storage item being accessed. The VFS may automatically map the file names, folder names, or full path names to the locations at which the storage items are stored. As an example and not by way of limitation, a storage item's location may be specified by the name, address, or identity of the FSVM that provides access to the storage item on the host machine on which the storage item is located. A storage item such as a file may be divided into multiple parts that may be located on different FSVMs, in which case access requests for a particular portion of the file may be automatically mapped to the location of the portion of the file based on the portion of the file being accessed (e.g., the offset from the beginning of the file and the number of bytes being accessed).

In particular embodiments, VFS 312 determines the location, e.g., FSVM, at which to store a storage item when the storage item is created. For example, a FSVM 302 may attempt to create a file or folder using a CVM 124 on the same host machine 102 as the user VM 114 that requested creation of the file, so that the CVM 124 that controls access operations to the file folder is co-located with the user VM 114. In this way, since the user VM 114 is known to be associated with the file or folder and is thus likely to access the file again, e.g., in the near future or on behalf of the same user, access operations may use local communication or short-distance communication to improve performance, e.g., by reducing access times or increasing access throughput. If there is a local CVM on the same host machine as the FSVM, the FSVM may identify it and use it by default. If there is no local CVM on the same host machine as the FSVM, a delay may be incurred for communication between the FSVM and a CVM on a different host machine. Further, the VFS 312 may also attempt to store the file on a storage device that is local to the CVM being used to create the file, such as local storage, so that storage access operations between the CVM and local storage may use local or short-distance communication.

In particular embodiments, if a CVM is unable to store the storage item in local storage of a host machine on which an FSVM resides, e.g., because local storage does not have sufficient available free space, then the file may be stored in local storage of a different host machine. In this case, the stored file is not physically local to the host machine, but storage access operations for the file are performed by the locally-associated CVM and FSVM, and the CVM may communicate with local storage on the remote host machine using a network file sharing protocol, e.g., iSCSI, SAMBA, or the like.

In particular embodiments, if a virtual machine, such as a user VM 112, CVM 124, or FSVM 302, moves from a host machine 102 to a destination host machine 202, e.g., because of resource availability changes, and data items such as files or folders associated with the VM are not locally accessible on the destination host machine 202, then data migration may be performed for the data items associated with the moved VM to migrate them to the new host machine 202, so that they are local to the moved VM on the new host machine 202. FSVMs may detect removal and addition of CVMs (as may occur, for example, when a CVM fails or is shut down) via the iSCSI protocol or other technique, such as heartbeat messages. As another example, a FSVM may determine that a particular file's location is to be changed, e.g., because a disk on which the file is stored is becoming full, because changing the file's location is likely to reduce network communication delays and therefore improve performance, or for other reasons. Upon determining that a file is to be moved, VFS 312 may change the location of the file by, for example, copying the file from its existing location(s), such as 136 of a host machine 102, to its new location(s), such as 138 of host machine 202 (and to or from other host machines, such as 140 of host machine 106 if appropriate), and deleting the file from its existing location(s). Write operations on the file may be blocked or queued while the file is being copied, so that the copy is consistent. The VFS 312 may also redirect storage access requests for the file from an FSVM at the file's existing location to a FSVM at the file's new location.

In particular embodiments, VFS 312 includes at least three File Server Virtual Machines (FSVMs) 302, 304, 306 located on three respective host machines 102, 202, 106. To provide high-availability, there may be a maximum of one FSVM for a particular VFS instance VFS 312 per host machine in a cluster. If two FSVMs are detected on a single host machine, then one of the FSVMs may be moved to another host machine automatically, or the user (e.g., system administrator) may be notified to move the FSVM to another host machine. The user may move a FSVM to another host machine using an administrative interface that provides commands for starting, stopping, and moving FSVMs between host machines.

In particular embodiments, two FSVMs of different VFS instances may reside on the same host machine. If the host machine fails, the FSVMs on the host machine become unavailable, at least until the host machine recovers. Thus, if there is at most one FSVM for each VFS instance on each host machine, then at most one of the FSVMs may be lost per VFS per failed host machine. As an example, if more than one FSVM for a particular VFS instance were to reside on a host machine, and the VFS instance includes three host machines and three FSVMs, then loss of one host machine would result in loss of two-thirds of the FSVMs for the VFS instance, which would be more disruptive and more difficult to recover from than loss of one-third of the FSVMs for the VFS instance.

In particular embodiments, users, such as system administrators or other users of the user VMs, may expand the cluster of FSVMs by adding additional FSVMs. Each FSVM may be associated with at least one network address, such as an IP (Internet Protocol) address of the host machine on which the FSVM resides. There may be multiple clusters, and all FSVMs of a particular VFS instance are ordinarily in the same cluster. The VFS instance may be a member of a MICROSOFT ACTIVE DIRECTORY domain, which may provide authentication and other services such as name service.

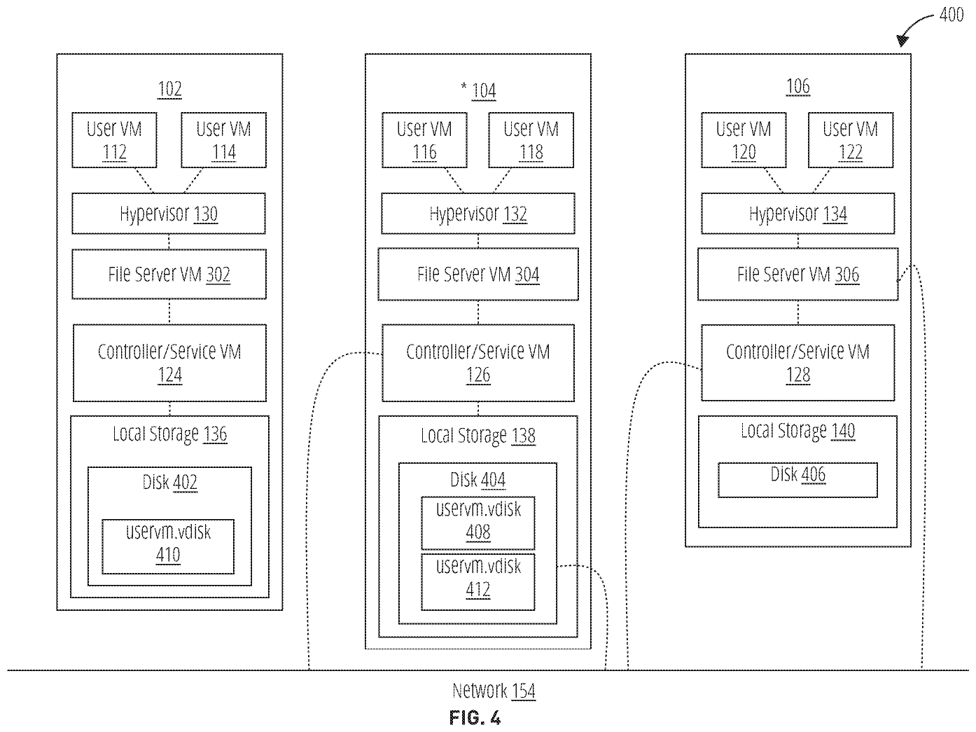

FIG. 4 illustrates data flow within a clustered virtualization environment 400 implementing a VFS instance (e.g, VFS 312) in which stored items such as files and folders used by user VMs are stored locally on the same host machines as the user VMs according to particular embodiments. As described above, one or more user VMs and a Controller/Service VM may run on each host machine along with a hypervisor. As a user VM processes I/O commands (e.g., a read or write operation), the I/O commands may be sent to the hypervisor on the same server or host machine as the user VM. For example, the hypervisor may present to the user VMs a VFS instance, receive an I/O command, and facilitate the performance of the I/O command by passing the command to a FSVM that performs the operation specified by the command. The VFS may facilitate I/O operations between a user VM and a virtualized file system. The virtualized file system may appear to the user VM as a namespace of mappable shared drives or mountable network file systems of files and directories. The namespace of the virtualized file system may be implemented using storage devices in the local storage, such as disks, onto which the shared drives or network file systems, files, and folders, or portions thereof, may be distributed as determined by the FSVMs. The VFS may thus provide features disclosed herein, such as efficient use of the disks, high availability, scalability, and others. The implementation of these features may be transparent to the user VMs. The FSVMs may present the storage capacity of the disks of the host machines as an efficient, highly-available, and scalable namespace in which the user VMs may create and access shares, files, folders, and the like.

As an example, a network share may be presented to a user VM as one or more discrete virtual disks, but each virtual disk may correspond to any part of one or more virtual or physical disks within a storage pool. Additionally or alternatively, the FSVMs may present a VFS either to the hypervisor or to user VMs of a host machine to facilitate I/O operations. The FSVMs may access the local storage via Controller/Service VMs. As described above with reference to FIG. 2, a 124 may have the ability to perform I/O operations using 136 within the same host machine 102 by connecting via the network 154 to cloud storage or NAS, or by connecting via the network 154 to 138, 140 within another host machine 104, 106 (e.g., by connecting to another 126, 128).

In particular embodiments, each user VM may access one or more virtual disk images stored on one or more disks of the local storage, the cloud storage, and/or the NAS. The virtual disk images may contain data used by the user VMs, such as operating system images, application software, and user data, e.g., user home folders and user profile folders. For example, FIG. 4 illustrates three virtual machine images 410, 408, 412. The virtual machine image 410 may be a file named UserVM.vmdisk (or the like) stored on disk 402 of 136 of host machine 102. The virtual machine image 410 may store the contents of the 112's hard drive. The disk 402 on which the virtual machine image 410 is “local to” the 112 on host machine 102 because the disk 402 is in 136 of the host machine 102 on which the 112 is located. Thus, the 112 may use local (intra-host machine) communication to access the virtual machine image 410 more efficiently, e.g., with less latency and higher throughput, than would be the case if the virtual machine image 410 were stored on disk 404 of 138 of a different host machine 104, because inter-host machine communication across the network 154 would be used in the latter case. Similarly, a virtual machine image 408, which may be a file named UserVM.vmdisk (or the like), is stored on disk 404 of 138 of host machine 104, and the image 408 is local to the 116 located on host machine 104. Thus, the 116 may access the virtual machine image 408 more efficiently than the virtual machine 114 on host machine 102, for example. In another example, the CVM 128 may be located on the same host machine 106 as the 120 that accesses a virtual machine image 412 (UserVM.vmdisk) of the 120, with the virtual machine image file 412 being stored on a different host machine 104 than the 120 and the 128. In this example, communication between the 120 and the CVM 128 may still be local, e.g., more efficient than communication between the 120 and a CVM 126 on a different host machine 104, but communication between the CVM 128 and the disk 404 on which the virtual machine image 412 is stored is via the network 154, as shown by the dashed lines between CVM 128 and the network 154 and between the network 154 and 138. The communication between CVM 128 and the disk 404 is not local, and thus may be less efficient than local communication such as may occur between the CVM 128 and a disk 406 in 140 of host machine 106. Further, a 120 on host machine 106 may access data such as the virtual disk image 412 stored on a remote (e.g., non-local) disk 404 via network communication with a CVM 126 located on the remote host machine 104. This case may occur if CVM 128 is not present on host machine 106, e.g., because CVM 128 has failed, or if the FSVM 306 has been configured to communicate with 138 on host machine 104 via the CVM 126 on host machine 104, e.g., to reduce computational load on host machine 106.

In particular embodiments, since local communication is expected to be more efficient than remote communication, the FSVMs may store storage items, such as files or folders, e.g., the virtual disk images, as block-level data on local storage of the host machine on which the user VM that is expected to access the files is located. A user VM may be expected to access particular storage items if, for example, the storage items are associated with the user VM, such as by configuration information. For example, the virtual disk image 410 may be associated with the 112 by configuration information of the 112. Storage items may also be associated with a user VM via the identity of a user of the user VM. For example, files and folders owned by the same user ID as the user who is logged into the 112 may be associated with the 112. If the storage items expected to be accessed by a 112 are not stored on the same host machine 102 as the 112, e.g., because of insufficient available storage capacity in 136 of the host machine 102, or because the storage items are expected to be accessed to a greater degree (e.g., more frequently or by more users) by a 116 on a different host machine 104, then the 112 may still communicate with a local CVM 124 to access the storage items located on the remote host machine 104, and the local CVM 124 may communicate with 138 on the remote host machine 104 to access the storage items located on the remote host machine 104. If the 112 on a host machine 102 does not or cannot use a local CVM 124 to access the storage items located on the remote host machine 104, e.g., because the local CVM 124 has crashed or the 112 has been configured to use a remote CVM 126, then communication between the 112 and 138 on which the storage items are stored may be via a remote CVM 126 using the network 154, and the remote CVM 126 may access 138 using local communication on host machine 104. As another example, a 112 on a host machine 102 may access storage items located on a disk 406 of 140 on another host machine 106 via a CVM 126 on an intermediary host machine 104 using network communication between the host machines 102 and 104 and between the host machines 104 and 106.

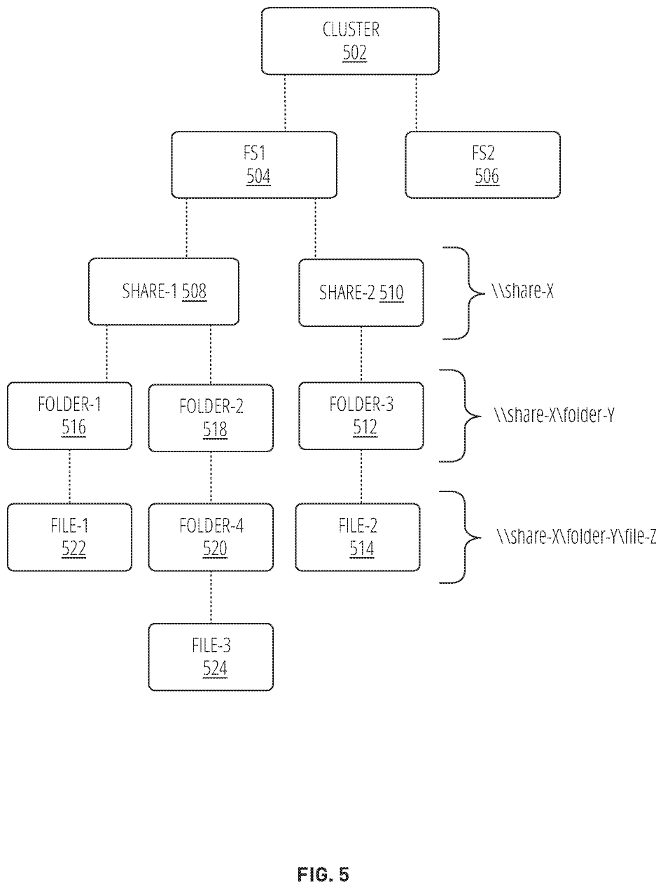

FIG. 5 illustrates an example hierarchical structure of a VFS instance in a cluster according to particular embodiments. A Cluster 502 contains two VFS instances, FS1 504 and FS2 506. Each VFS instance may be identified by a name such as “\\instance”, e.g., “\\FS1” for WINDOWS file systems, or a name such as “instance”, e.g., “FS1” for UNIX-type file systems. The VFS instance FS1 504 contains shares, including Share-1 508 and Share-2 510. Shares may have names such as “Users” for a share that stores user home directories, or the like. Each share may have a path name such as \\FS1\Share-1 or \\FS1\Users. As an example and not by way of limitation, a share may correspond to a disk partition or a pool of file system blocks on WINDOWS and UNIX-type file systems. As another example and not by way of limitation, a share may correspond to a folder or directory on a VFS instance. Shares may appear in the file system instance as folders or directories to users of user VMs. Share-1 508 includes two folders, Folder-1 516, and Folder-2 518, and may also include one or more files (e.g., files not in folders). Each folder 516, 518 may include one or more files 522, 524. Share-2 510 includes a folder Folder-3 512, which includes a file File-2 514. Each folder has a folder name such as “Folder-1”, “Users”, or “Sam” and a path name such as “\\FS1\Share-1\Folder-1” (WINDOWS) or “share-1:/fs1/Users/Sam” (UNIX). Similarly, each file has a file name such as “File-i” or “Forecast.xls” and a path name such as “\\FS1\Share-1\Folder-1\File-1” or “share-1:/fs1/Users/Sam/Forecast.xls”.

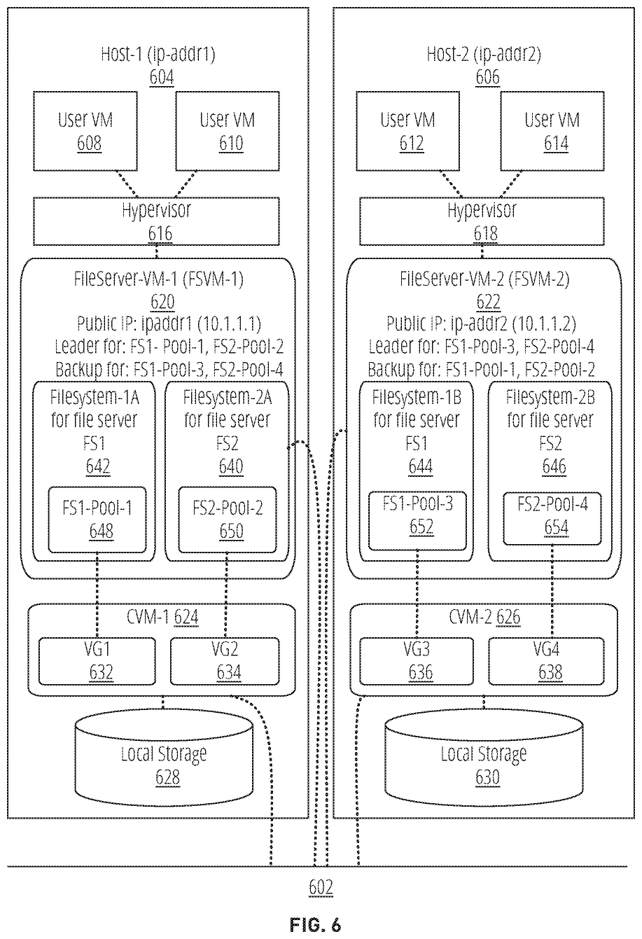

FIG. 6 illustrates two example host machines 102 and 606, each providing file storage services for portions of two VFS instances FS1 and FS2 according to particular embodiments. The first host machine, Host-1 102, includes two user VMs 608, 610, a Hypervisor 616, a FSVM named FileServer-VM-1 (abbreviated FSVM-1) 620, a Controller/Service VM named CVM-1 624, and local storage 628. Host-1's FileServer-VM-1 620 has an IP (Internet Protocol) network address of 10.1.1.1, which is an address of a network interface on Host-1 102. Host-1 has a hostname ip-addr1, which may correspond to Host-1's IP address 10.1.1.1. The second host machine, Host-2 606, includes two user VMs 612, 614, a Hypervisor 618, a File Server VM named FileServer-VM-2 (abbreviated FSVM-2) 622, a Controller/Service VM named CVM-2 626, and local storage 630. Host-2's FileServer-VM-2 622 has an IP network address of 10.1.1.2, which is an address of a network interface on Host-2 606.

In particular embodiments, file systems FileSystem-1A 642 and FileSystem-2A 640 implement the structure of files and folders for portions of the FS1 and FS2 file server instances, respectively, that are located on (e.g., served by) FileServer-VM-1 620 on Host-1 102. Other file systems on other host machines may implement other portions of the FS1 and FS2 file server instances. The file systems 642 and 640 may implement the structure of at least a portion of a file server instance by translating file system operations, such as opening a file, writing data to or reading data from the file, deleting a file, and so on, to disk 1/O operations such as seeking to a portion of the disk, reading or writing an index of file information, writing data to or reading data from blocks of the disk, allocating or de-allocating the blocks, and so on. The file systems 642, 640 may thus store their file system data, including the structure of the folder and file hierarchy, the names of the storage items (e.g., folders and files), and the contents of the storage items on one or more storage devices, such as local storage 628. The particular storage device or devices on which the file system data for each file system are stored may be specified by an associated file system pool (e.g., 648 and 650). For example, the storage device(s) on which data for FileSystem-1A 642 and FileSystem-2A, 640 are stored may be specified by respective file system pools FS1-Pool-1 648 and FS2-Pool-2 650. The storage devices for the pool may be selected from volume groups provided by CVM-1 624, such as volume group VG1 632 and volume group VG2 634. Each volume group 632, 634 may include a group of one or more available storage devices that are present in local storage 628 associated with (e.g., by iSCSI communication) the CVM-1 624. The CVM-1 624 may be associated with a local storage 628 on the same host machine 102 as the CVM-1 624, or with a local storage 630 on a different host machine 606. The CVM-1 624 may also be associated with other types of storage, such as cloud storage, networked storage or the like. Although the examples described herein include particular host machines, virtual machines, file servers, file server instances, file server pools, CVMs, volume groups, and associations there between, any number of host machines, virtual machines, file servers, file server instances, file server pools, CVMs, volume groups, and any associations there between are possible and contemplated.

In particular embodiments, the file system pool 648 may associate any storage device in one of the volume groups 632, 634 of storage devices that are available in local storage 628 with the file system FileSystem-1A 642. For example, the file system pool FS1-Pool-1 648 may specify that a disk device named hd1 in the volume group VG1 632 of local storage 628 is a storage device for FileSystem-1A 642 for file server FS1 on FSVM-1 620. A file system pool FS2-Pool-2 650 may specify a storage device FileSystem-2A 650 for file server FS2 on FSVM-1 620. The storage device for FileSystem-2A 640 may be, e.g., the disk device hd1, or a different device in one of the volume groups 632, 634, such as a disk device named hd2 in volume group VG2 634. Each of the file systems FileSystem-1A 642, FileSystem-2A 640 may be, e.g., an instance of the NTFS file system used by the WINDOWS operating system, of the UFS Unix file system, or the like. The term “file system” may also be used herein to refer to an instance of a type of file system, e.g., a particular structure of folders and files with particular names and content.

In one example, referring to FIG. 5 and FIG. 6, an FS1 hierarchy rooted at File Server FS1 504 may be located on FileServer-VM-1 620 and stored in file system instance FileSystem-1A 642. That is, the file system instance FileSystem-1A 642 may store the names of the shares and storage items (such as folders and files), as well as the contents of the storage items, shown in the hierarchy at and below File Server FS1 504. A portion of the FS1 hierarchy shown in FIG. 5, such the portion rooted at Folder-2 518, may be located on FileServer-VM-2 622 on Host-2 606 instead of FileServer-VM-1 620, in which case the file system instance FileSystem-1B 644 may store the portion of the FS1 hierarchy rooted at Folder-2 518, including Folder-3 512, Folder-4 520 and File-3 524. Similarly, an FS2 hierarchy rooted at File Server FS2 506 in FIG. 5 may be located on FileServer-VM-1 620 and stored in file system instance FileSystem-2A 640. The FS2 hierarchy may be split into multiple portions (not shown), such that one portion is located on FileServer-VM-1 620 on Host-1 102, and another portion is located on FileServer-VM-2 622 on Host-2 606 and stored in file system instance FileSystem-2B 646.

In particular embodiments, FileServer-VM-1 (abbreviated FSVM-1) 620 on Host-1 102 is a leader for a portion of file server instance FS1 and a portion of FS2, and is a backup for another portion of FS1 and another portion of FS2. The portion of FS1 for which FileServer-VM-1 620 is a leader corresponds to a storage pool labeled FS1-Pool-1 648. FileServer-VM-1 is also a leader for FS2-Pool-2 650, and is a backup (e.g., is prepared to become a leader upon request, such as in response to a failure of another FSVM) for FS1-Pool-3 652 and FS2-Pool-4 654 on Host-2 606. In particular embodiments, FileServer-VM-2 (abbreviated FSVM-2) 622 is a leader for a portion of file server instance FS1 and a portion of FS2, and is a backup for another portion of FS1 and another portion of FS2. The portion of FS1 for which FSVM-2 622 is a leader corresponds to a storage pool labeled FS1-Pool-3 652. FSVM-2 622 is also a leader for FS2-Pool-4 654, and is a backup for FS1-Pool-1 648 and FS2-Pool-2 650 on Host-1 102.

In particular embodiments, the file server instances FS1, FS2 provided by the FSVMs 620 and 622 may be accessed by user VMs 608, 610, 612 and 614 via a network file system protocol such as SMB, CIFS, NFS, or the like. Each FSVM 620 and 622 may provide what appears to client applications on user VMs 608, 610, 612 and 614 to be a single file system instance, e.g., a single namespace of shares, files and folders, for each file server instance. However, the shares, files, and folders in a file server instance such as FS1 may actually be distributed across multiple FSVMs 620 and 622. For example, different folders in the same file server instance may be associated with different corresponding FSVMs 620 and 622 and CVMs 624 and 626 on different host machines 102 and 606.

The example file server instance FS1 504 shown in FIG. 5 has two shares, Share-1 508 and Share-2 510. Share-1 508 may be located on FSVM-1 620, CVM-1 624, and local storage 628. Network file system protocol requests from user VMs to read or write data on file server instance FS1 504 and any share, folder, or file in the instance may be sent to FSVM-1 620. FSVM-1 620 may determine whether the requested data, e.g., the share, folder, file, or a portion thereof, referenced in the request, is located on FSVM-1, and FSVM-1 is a leader for the requested data. If not, FSVM-1 may respond to the requesting User-VM with an indication that the requested data is not covered by (e.g., is not located on or served by) FSVM-1. Otherwise, the requested data is covered by (e.g., is located on or served by) FSVM-1, so FSVM-1 may send iSCSI protocol requests to a CVM that is associated with the requested data. Note that the CVM associated with the requested data may be the CVM-1 624 on the same host machine 102 as the FSVM-1, or a different CVM on a different host machine 606, depending on the configuration of the VFS. In this example, the requested Share-1 is located on FSVM-1, so FSVM-1 processes the request. To provide for path availability, multipath I/O (MPIO) may be used for communication with the FSVM, e.g., for communication between FSVM-1 and CVM-1. The active path may be set to the CVM that is local to the FSVM (e.g., on the same host machine) by default. The active path may be set to a remote CVM instead of the local CVM, e.g., when a failover occurs.

Continuing with the data request example, the associated CVM is CVM 624, which may in turn access the storage device associated with the requested data as specified in the request, e.g., to write specified data to the storage device or read requested data from a specified location on the storage device. In this example, the associated storage device is in local storage 628, and may be an HDD or SSD. CVM-1 624 may access the HDD or SSD via an appropriate protocol, e.g., iSCSI, SCSI, SATA, or the like. CVM 110a may send the results of accessing local storage 628, e.g., data that has been read, or the status of a data write operation, to CVM 624 via, e.g., SATA, which may in turn send the results to FSVM-1 620 via, e.g., iSCSI. FSVM-1 620 may then send the results to user VM via SMB through the Hypervisor 616.

Share-2 510 may be located on FSVM-2 622, on Host-2. Network file service protocol requests from user VMs to read or write data on Share-2 may be directed to FSVM-2 622 on Host-2 by other FSVMs. Alternatively, user VMs may send such requests directly to FSVM-2 622 on Host-2, which may process the requests using CVM-2 626 and local storage 630 on Host-2 as described above for FSVM-1 620 on Host-1.

A file server instance such as FS1 504 in FIG. 5 may appear as a single file system instance (e.g., a single namespace of folders and files that are accessible by their names or pathnames without regard for their physical locations), even though portions of the file system are stored on different host machines. Since each FSVM may provide a portion of a file server instance, each FSVM may have one or more “local” file systems that provide the portion of the file server instance (e.g., the portion of the namespace of files and folders) associated with the FSVM.

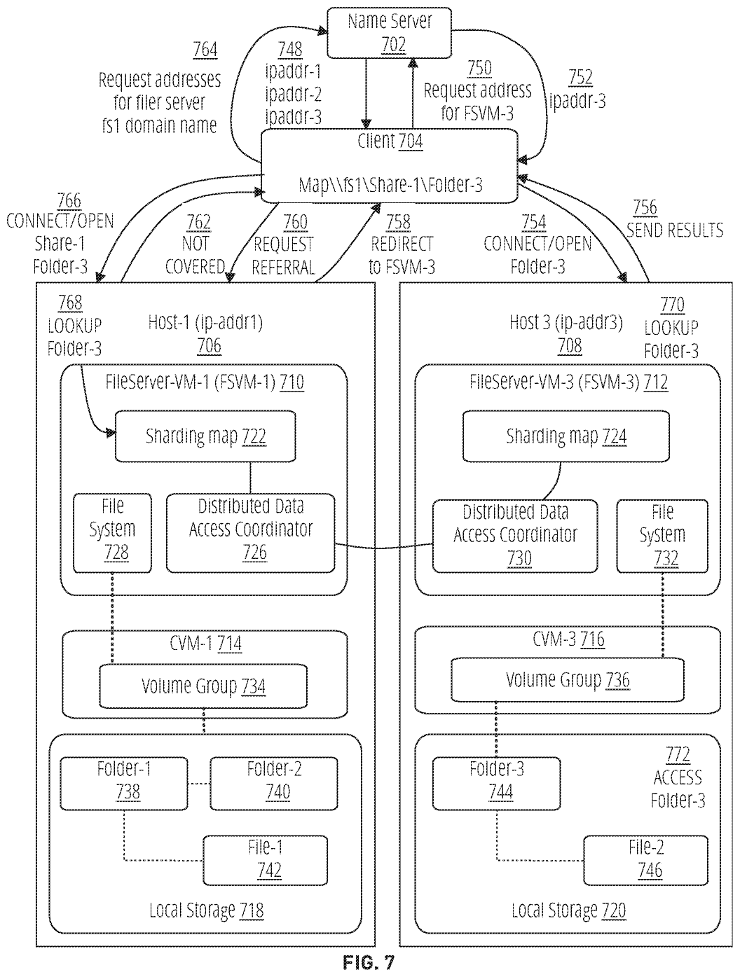

FIG. 7 illustrates example interactions between a client 704 and host machines 706 and 708 on which different portions of a VFS instance are stored according to particular embodiments. A client 704, e.g., an application program executing in one of the user VMs and on the host machines of FIGS. 3-4 requests access to a folder \\FS1.domain.name\Share-1\Folder-3. The request may be in response to an attempt to map \\FS1.domain.name\Share-1 to a network drive in the operating system executing in the user VM followed by an attempt to access the contents of Share-1 or to access the contents of Folder-3, such as listing the files in Folder-3.

FIG. 7 shows interactions that occur between the client 704, FSVMs 710 and 712 on host machines 706 and 708, and a name server 702 when a storage item is mapped or otherwise accessed. The name server 702 may be provided by a server computer system, such as one or more of the host machines 706, 708 or a server computer system separate from the host machines 706, 708. In one example, the name server 702 may be provided by an ACTIVE DIRECTORY service executing on one or more computer systems and accessible via the network. The interactions are shown as arrows that represent communications, e.g., messages sent via the network. Note that the client 704 may be executing in a user VM, which may be co-located with one of the FSVMs 710 and 712. In such a co-located case, the arrows between the client 704 and the host machine on which the FSVM is located may represent communication within the host machine, and such intra-host machine communication may be performed using a mechanism different from communication over the network, e.g., shared memory or inter process communication.

In particular embodiments, when the client 704 requests access to Folder-3, a VFS client component executing in the user VM may use a distributed file system protocol such as MICROSOFT DFS, or the like, to send the storage access request to one or more of the FSVMs of FIGS. 3-4. To access the requested file or folder, the client determines the location of the requested file or folder, e.g., the identity and/or network address of the FSVM on which the file or folder is located. The client may query a domain cache of FSVM network addresses that the client has previously identified (e.g., looked up). If the domain cache contains the network address of an FSVM associated with the requested folder name \\FS1.domain.name\Share-1\Folder-3, then the client retrieves the associated network address from the domain cache and sends the access request to the network address, starting at step 764 as described below.

In particular embodiments, at step 764, the client may send a request for a list of addresses of FSVMs to a name server 702. The name server 702 may be, e.g., a DNS server or other type of server, such as a MICROSOFT domain controller (not shown), that has a database of FSVM addresses. At step 748, the name server 702 may send a reply that contains a list of FSVM network addresses, e.g., ip-addr1, ip-addr2, and ip-addr3, which correspond to the FSVMs in this example. At step 766, the client 704 may send an access request to one of the network addresses, e.g., the first network address in the list (ip-addr1 in this example), requesting the contents of Folder-3 of Share-1. By selecting the first network address in the list, the particular FSVM to which the access request is sent may be varied, e.g., in a round-robin manner by enabling round-robin DNS (or the like) on the name server 702. The access request may be, e.g., an SMB connect request, an NFS open request, and/or appropriate request(s) to traverse the hierarchy of Share-1 to reach the desired folder or file, e.g., Folder-3 in this example.

At step 768, FileServer-VM-1 710 may process the request received at step 766 by searching a mapping or lookup table, such as a sharding map 722, for the desired folder or file. The map 722 maps stored objects, such as shares, folders, or files, to their corresponding locations, e.g., the names or addresses of FSVMs. The map 722 may have the same contents on each host machine, with the contents on different host machines being synchronized using a distributed data store as described below. For example, the map 722 may contain entries that map Share-1 and Folder-1 to the File Server FSVM-1 710, and Folder-3 to the File Server FSVM-3 712. An example map is shown in Table 1 below.

| Stored Object | Location |
|---|---|
| Folder-1 | FSVM-1 |
| Folder-2 | FSVM-1 |
| File-1 | FSVM-1 |
| Folder-3 | FSVM-3 |
| File-2 | FSVM-3 |

In particular embodiments, the map 722 or 724 may be accessible on each of the host machines. As described with reference to FIGS. 3-4, the maps may be copies of a distributed data structure that are maintained and accessed at each FSVM using a distributed data access coordinator 726 and 730. The distributed data access coordinator 726 and 730 may be implemented based on distributed locks or other storage item access operations. Alternatively, the distributed data access coordinator 726 and 730 may be implemented by maintaining a master copy of the maps 722 and 724 at a leader node such as the host machine 708, and using distributed locks to access the master copy from each FSVM 710 and 712. The distributed data access coordinator 726 and 730 may be implemented using distributed locking, leader election, or related features provided by a centralized coordination service for maintaining configuration information, naming, providing distributed synchronization, and/or providing group services (e.g., APACHE ZOOKEEPER or other distributed coordination software). Since the map 722 indicates that Folder-3 is located at FSVM-3 712 on Host-3 708, the lookup operation at step 768 determines that Folder-3 is not located at FSVM-1 on Host-1 706. Thus, at step 762 the FSVM-1 710 sends a response, e.g., a “Not Covered” DFS response, to the client 704 indicating that the requested folder is not located at FSVM-1. At step 760, the client 704 sends a request to FSVM-1 for a referral to the FSVM on which Folder-3 is located. FSVM-1 uses the map 722 to determine that Folder-3 is located at FSVM-3 on Host-3 708, and at step 758 returns a response, e.g., a “Redirect” DFS response, redirecting the client 704 to FSVM-3. The client 704 may then determine the network address for FSVM-3, which is ip-addr3 (e.g., a host name “ip-addr3.domain.name” or an IP address, 10.1.1.3). The client 704 may determine the network address for FSVM-3 by searching a cache stored in memory of the client 704, which may contain a mapping from FSVM-3 to ip-addr3 cached in a previous operation. If the cache does not contain a network address for FSVM-3, then at step 750 the client 704 may send a request to the name server 702 to resolve the name FSVM-3. The name server may respond with the resolved address, ip-addr3, at step 752. The client 704 may then store the association between FSVM-3 and ip-addr3 in the client's cache.

In particular embodiments, failure of FSVMs may be detected using the centralized coordination service. For example, using the centralized coordination service, each FSVM may create a lock on the host machine on which the FSVM is located using ephemeral nodes of the centralized coordination service (which are different from host machines but may correspond to host machines). Other FSVMs may volunteer for leadership of resources of remote FSVMs on other host machines, e.g., by requesting a lock on the other host machines. The locks requested by the other nodes are not granted unless communication to the leader host machine is lost, in which case the centralized coordination service deletes the ephemeral node and grants the lock to one of the volunteer host machines and, which becomes the new leader. For example, the volunteer host machines may be ordered by the time at which the centralized coordination service received their requests, and the lock may be granted to the first host machine on the ordered list. The first host machine on the list may thus be selected as the new leader. The FSVM on the new leader has ownership of the resources that were associated with the failed leader FSVM until the failed leader FSVM is restored, at which point the restored FSVM may reclaim the local resources of the host machine on which it is located.

At step 754, the client 704 may send an access request to FSVM-3 712 at ip-addr3 on Host-3 708 requesting the contents of Folder-3 of Share-1. At step 770, FSVM-3 712 queries FSVM-3's copy of the map 724 using FSVM-3's instance of the distributed data access coordinator 730. The map 724 indicates that Folder-3 is located on FSVM-3, so at step 772 FSVM-3 accesses the file system 732 to retrieve information about Folder-3 744 and its contents (e.g., a list of files in the folder, which includes File-2 746) that are stored on the local storage 720. FSVM-3 may access local storage 720 via CVM-3 716, which provides access to local storage 720 via a volume group 736 that contains one or more volumes stored on one or more storage devices in local storage 720. At step 756, FSVM-3 may then send the information about Folder-3 and its contents to the client 704. Optionally, FSVM-3 may retrieve the contents of File-2 and send them to the client 704, or the client 704 may send a subsequent request to retrieve File-2 as needed.

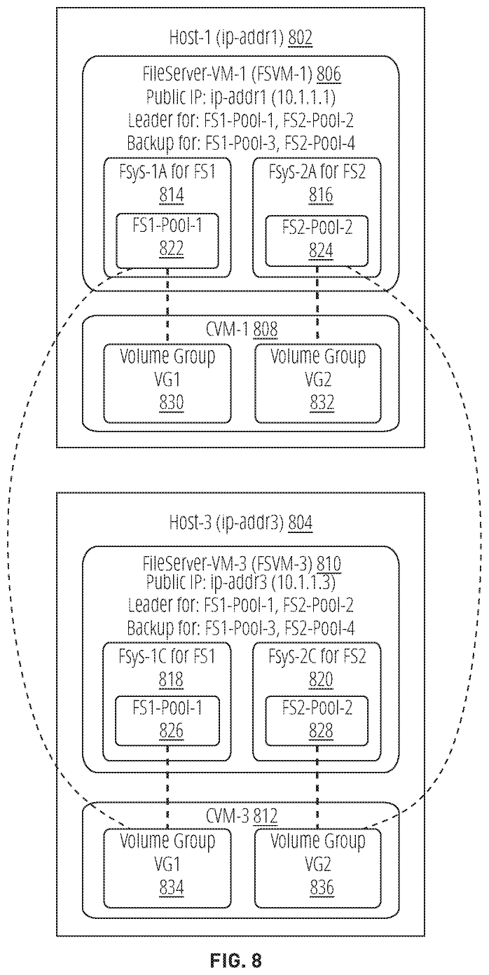

FIG. 8 illustrates an example virtualized file server having a failover capability according to particular embodiments. To provide high availability, e.g., so that the file server continues to operate after failure of components such as a CVM, FSVM, or both, as may occur if a host machine fails, components on other host machines may take over the functions of failed components. When a CVM fails, a CVM on another host machine may take over input/output operations for the failed CVM. Further, when an FSVM fails, an FSVM on another host machine may take over the network address and CVM or volume group that were being used by the failed FSVM. If both an FSVM and an associated CVM on a host machine fail, as may occur when the host machine fails, then the FSVM and CVM on another host machine may take over for the failed FSVM and CVM. When the failed FSVM and/or CVM are restored and operational, the restored FSVM and/or CVM may take over the operations that were being performed by the other FSVM and/or CVM. In FIG. 8, FSVM-1 806 communicates with CVM-1 808 to use the data storage in volume groups VG1 830 and VG2 832. For example, FSVM-1 is using disks in VG1 and VG2, which are iSCSI targets. FSVM-1 has iSCSI initiators that communicate with the VG1 and VG2 targets using MPIO (e.g., DM-MPIO on the LINUX operating system). FSVM-1 may access the volume groups VG1 and VG2 via in-guest iSCSI. Thus, any FSVM may connect to any iSCSI target if an FSVM failure occurs.

In particular embodiments, during failure-free operation, there are active iSCSI paths between FSVM-1 and CVM-1, as shown in FIG. 8 by the dashed lines from the FSVM-1 file systems for FS1 814 and FS2 816 to CVM-1's volume group VG1 830 and VG2 832, respectively. Further, during failure-free operation there are inactive failover (e.g., standby) paths between FSVM-1 and CVM-3 812, which is located on Host-3. The failover paths may be, e.g., paths that are ready to be activated in response to the local CVM CVM-1 becoming unavailable. There may be additional failover paths that are not shown in FIG. 8. For example, there may be failover paths between FSVM-1 and a CVM on another host machine. The local CVM CVM-1 808 may become unavailable if, for example, CVM-1 crashes, or the host machine on which the CVM-1 is located crashes, loses power, loses network communication between FSVM-1 806 and CVM-1 808. As an example and not by way of limitation, the failover paths do not perform I/O operations during failure-free operation. Optionally, metadata associated with a failed CVM 808, e.g., metadata related to volume groups 830, 832 associated with the failed CVM 808, may be transferred to an operational CVM, e.g., CVM 812, so that the specific configuration and/or state of the failed CVM 808 may be re-created on the operational CVM 812.

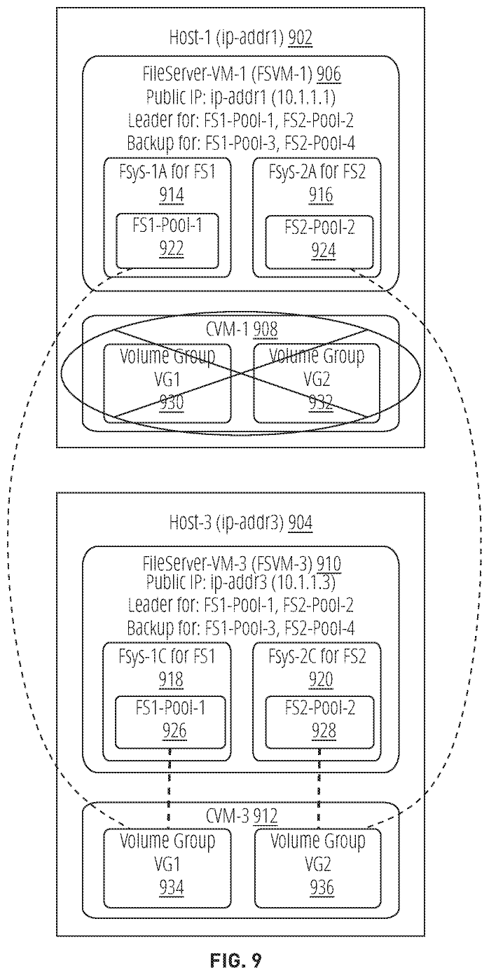

FIG. 9 illustrates an example virtualized file server that has recovered from a failure of Controller/Service VM CVM-1 908 by switching to an alternate Controller/Service VM CVM-3 912 according to particular embodiments. When CVM-1 908 fails or otherwise becomes unavailable, then the FSVM associated with CVM-1, FSVM-1 906, may detect a PATH DOWN status on one or both of the iSCSI targets for the volume groups VG1 930 and VG2 932, and initiate failover to a remote CVM that can provide access to those volume groups VG1 and VG2. For example, when CVM-1 908 fails, the iSCSI MPIO may activate failover (e.g., standby) paths to the remote iSCSI target volume group(s) associated with the remote CVM-3 912 on Host-3 904. CVM-3 provides access to volume groups VG1 and VG2 as VG1 934 and VG2 936, which are on storage device(s) of local storage. The activated failover path may take over I/O operations from failed CVM-1 908. Optionally, metadata associated with the failed CVM-1 908, e.g., metadata related to volume groups 930, 932, may be transferred to CVM-3 so that the specific configuration and/or state of CVM-1 may be re-created on CVM-3. When the failed CVM-1 again becomes available, e.g., after it has been re-started and has resumed operation, the path between FSVM-1 and CVM-1 may reactivated or marked as the active path, so that local I/O between CVM-1 and FSVM-1 may resume, and the path between CVM-3 and FSVM-1 may again become a failover (e.g., standby) path.

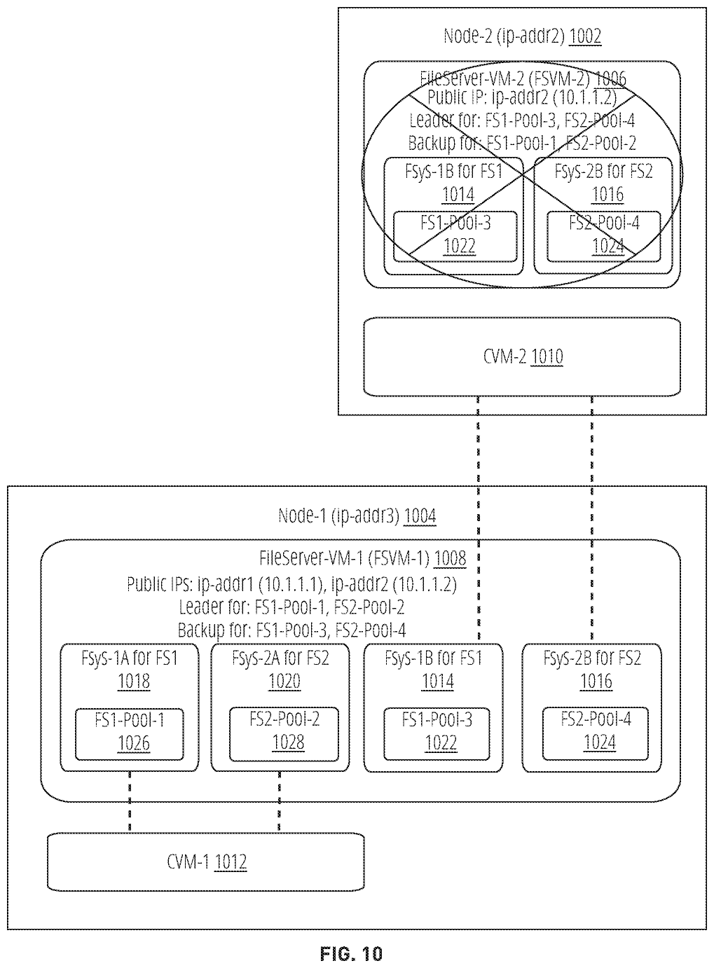

FIG. 10 illustrates an example virtualized file server that has recovered from failure of a FSVM by electing a new leader FSVM according to particular embodiments. When an FSVM-2 1006 fails, e.g., because it has been brought down for maintenance, has crashed, the host machine on which it was executing has been powered off or crashed, network communication between the FSVM and other FSVMs has become inoperative, or other causes, then the CVM that was being used by the failed FSVM, the CVM's associated volume group(s), and the network address of the host machine on which the failed FSVM was executing may be taken over by another FSVM to provide continued availability of the file services that were being provided by the failed FSVM. In the example shown in FIG. 10, FSVM-2 1006 on Host-2 1002 has failed. One or more other FSVMs, e.g., FSVM-1 1008 or FSVM-3, or other components located on one or more other host machines, may detect the failure of FSVM-2, e.g., by detecting a communication timeout or lack of response to a periodic status check message. When FSVM-2's failure is detected, an election may be held, e.g., using a distributed leader election process such as that provided by the centralized coordination service. The host machine that wins the election may become the new leader for the file system pools 1022, 1024 for which the failed FSVM-2 was the leader. In this example, FSVM-1 1008 wins the election and becomes the new leader for the pools 1022, 1024. FSVM-1 1008 thus attaches to CVM-2 1010 by creating file system 1014, 1016 instances for the file server instances FS1 and FS2 using FS1-Pool-3 1022 and FS2-Pool-4 1024, respectively. In this way, FSVM-1 takes over the file systems and pools for CVM-2's volume groups, e.g., volume groups VG1 and VG2 of local storage. Further, FSVM-1 takes over the IP address associated with FSVM-2, 10.1.1.2, so that storage access requests sent to FSVM-2 are received and processed by FSVM-1. Optionally, metadata used by FSVM-1, e.g., metadata associated with the file systems, may be transferred to FSVM-3 so that the specific configuration and/or state of the file systems may be re-created on FSVM-3. Host-2 1002 may continue to operate, in which case CVM-2 1010 may continue to execute on Host-2. When FSVM-2 again becomes available, e.g., after it has been re-started and has resumed operation, FSVM-2 may assert leadership and take back its IP address (10.1.1.2) and storage (FS1-Pool-3 1022 and FS2-Pool-4 1024) from FSVM-1.

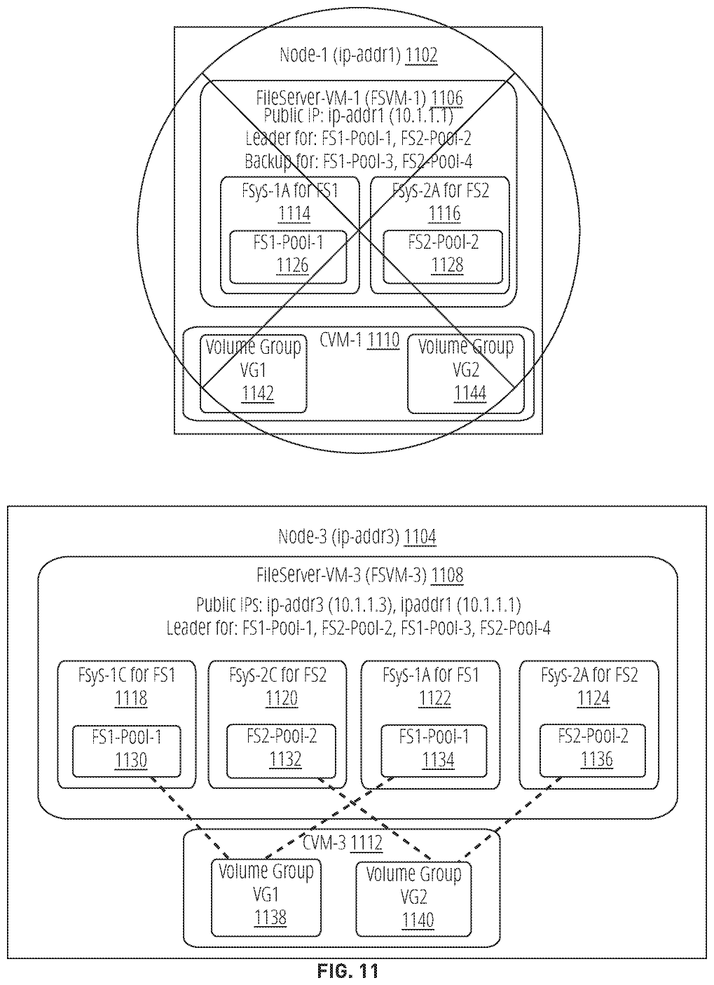

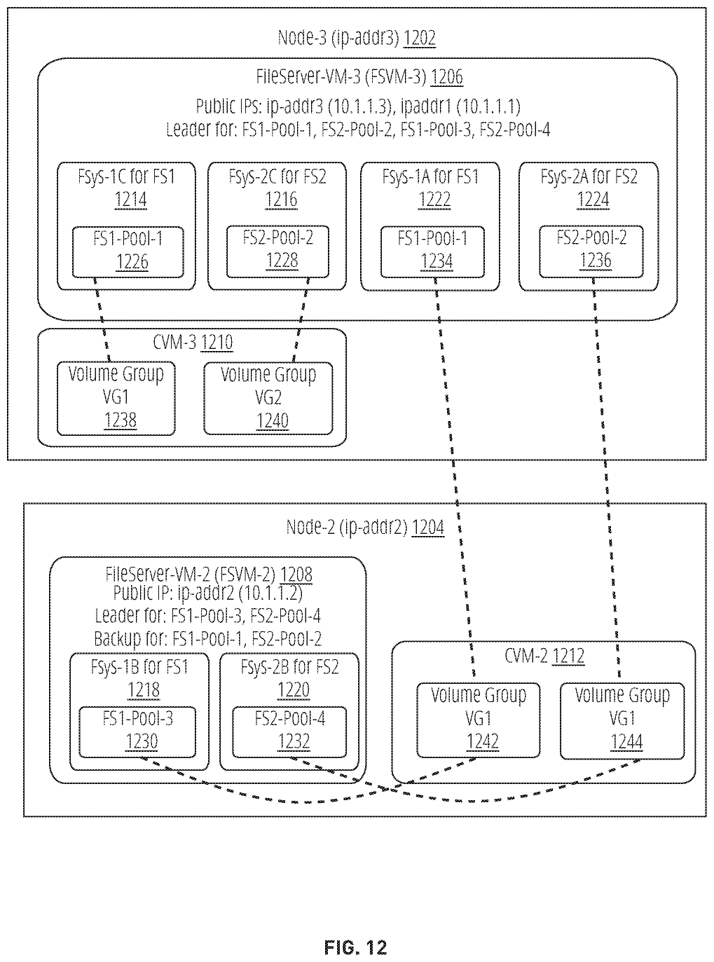

FIGS. 11 and 12 illustrate example virtualized file servers that have recovered from failure of a host machine by switching to another Controller/Service VM and another FSVM according to particular embodiments. The other Controller/Service VM and FSVM are located on a single host machine 1104 in FIG. 10, and on two different host machines 200b, 200c in FIG. 3H. In both FIGS. 3G and 3H, Host-1 has failed, e.g., crashed or otherwise become inoperative or unresponsive to network communication. Both FSVM-1 and CVM-1 located on the failed Host-1 have thus failed. Note that the CVM and FSVM on a particular host machine may both fail even if the host machine itself does not fail. Recovery from failure of a CVM and an FSVM located on the same host machine, regardless of whether the host machine itself failed, may be performed as follows. The failure of FSVM-1 and CVM-1 may be detected by one or more other FSVMs, e.g., FSVM-2, FSVM-3, or by other components located on one or more other host machines. FSVM-1's failure may be detected when a communication timeout occurs or there is no response to a periodic status check message within a timeout period, for example. CVM-1's failure may be detected when a PATH DOWN condition occurs on one or more of CVM-1's volume groups' targets (e.g., iSCSI targets).

When FSVM-1's failure is detected, an election may be held as described above with reference to FIG. 10 to elect an active FSVM to take over leadership of the portions of the file server instance for which the failed FSVM was the leader. These portions are FileSystem-1A 1122 for the portion of file server FS1 located on FSVM-1, and FileSystem-2A 1124 for the portion of file serverFS2 located on FSVM-1. FileSystem-1A 1122 uses the pool FS-Pool-1 FS1-Pool-1 1134 and FileSystem-2A 1124 uses the pool FS2-Pool-2 1136. Thus, the FileSystem-1A 364a and FileSystem-2A may be re-created on the new leader FSVM-3 1108 on Host-3 1104. Further, FSVM-3 1108 may take over the IP address associated with failed FSVM-1 1106, 10.1.1.1, so that storage access requests sent to FSVM-1 are received and processed by FSVM-3.

One or more failover paths from an FSVM to volume groups on one or more CVMs may be defined for use when a CVM fails. When CVM-1's failure is detected, the MPIO may activate one of the failover (e.g., standby) paths to remote iSCSI target volume group(s) associated with a remote CVM. For example, there may be a first predefined failover path from FSVM-1 to the volume groups VG1 1138, 1140 in CVM-3 (which are on the same host as FSVM-1 when FSVM-1 is restored on Host-3 in examples of FIGS. 11 and 12), and a second predefined failover path to the volume groups VG1 1242, VG2 1242 in CVM-2. The first failover path, to CVM-3, is shown in FIG. 11, and the second failover path, to CVM-2 is shown in FIG. 12. An FSVM or MPIO may choose the first or second failover path according to the predetermined MPIO failover configuration that has been specified by a system administrator or user. The failover configuration may indicate that the path is selected (a) by reverting to the previous primary path, (b) in order of most preferred path, (c) in a round-robin order, (d) to the path with the least number of outstanding requests, (e) to the path with the least weight, or (f) to the path with the least number of pending requests. When failure of CVM-1 is detected, e.g., by FSVM-1 or MPIO detecting a PATH DOWN condition on one of CVM-1's volume groups VG1 or VG2, the alternate CVM on the selected failover path may take over I/O operations from the failed CVM-1. As shown in FIG. 11, if the first failover path is chosen, CVM-3 1112 on Host-3 1104 is the alternate CVM, and the pools FS1-Pool-1 1134 and FS2-Pool-2 1136, used by the file systems FileSystem-1A 1122 and FileSystem-2A 1124, respectively, which have been restored on FSVM-3 on Host-3, may use volume groups VG1 1138 and VG2 1140 of CVM-3 1112 on Host-3 when the first failover path is chosen. Alternatively, as shown in FIG. 12, if the second failover path is chosen, CVM-2 on Host-2 is the alternate CVM, and the pools FS1-Pool-1 1234 and FS2-Pool-2 1236 used by the respective file systems FileSystem-1A 1222 and FileSystem-2A 1224, which have been restored on FSVM-3, may use volume groups VG1 1242 and VG2 1244 on Host-2, respectively.

Optionally, metadata used by FSVM-1 1106, e.g., metadata associated with the file systems, may be transferred to FSVM-3 as part of the recovery process so that the specific configuration and/or state of the file systems may be re-created on FSVM-3. Further, metadata associated with the failed CVM-1 1110, e.g., metadata related to volume groups 1142, 1144, may be transferred to the alternate CVM (e.g., CVM-2 or CVM-3) that the specific configuration and/or state of CVM-1 may be re-created on the alternative CVM. When FSVM-1 again becomes available, e.g., after it has been re-started and has resumed operation on Host-1 1102 or another host machine, FSVM-1 may assert leadership and take back its IP address (10.1.1.1) and storage assignments (FileSystem-1A and FS1-Pool-1 1126, and FileSystem-2A and FS2-Pool-2 1128) from FSVM-3. When CVM-1 again becomes available, MPIO or FSVM-1 may switch the FSVM to CVM communication paths (iSCSI paths) for FileSystem-1A 1114 and FileSystem-2A 1116 back to the pre-failure paths, e.g., the paths to volume groups VG1 1142 and 1144 in CVM-1 1110, or the selected alternate path may remain in use. For example, the MPIO configuration may specify that fail back to FSVM-1 is to occur when the primary path is restored, since communication between FSVM-1 and CVM-1 is local and may be faster than communication between FSVM-1 and CVM-2 or CVM-3. In this case, the paths between CVM-2 and/or CVM-3 and FSVM-1 may again become failover (e.g., standby) paths.

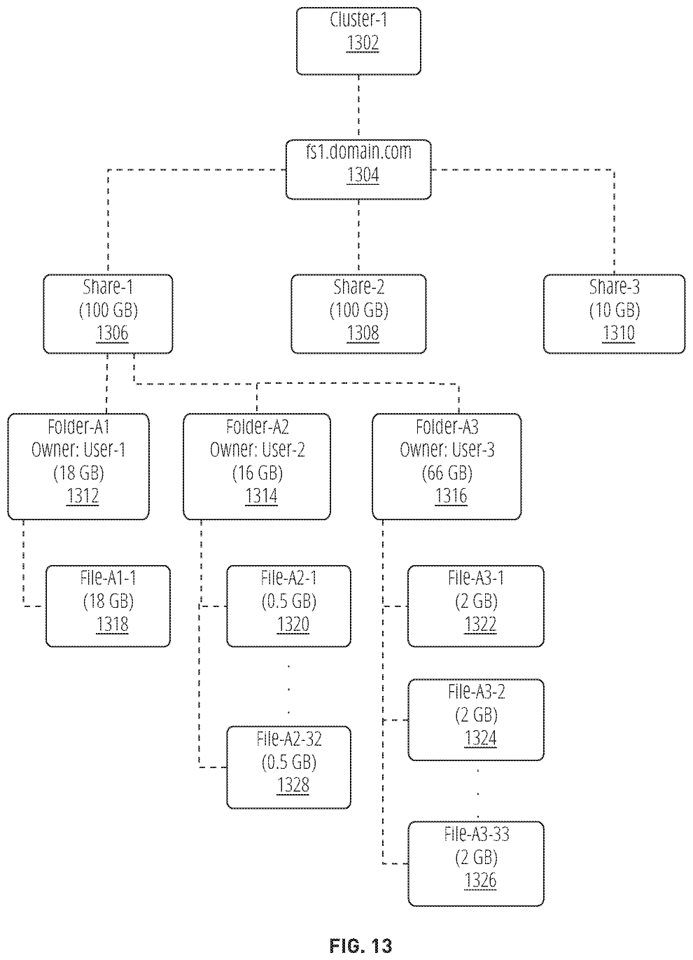

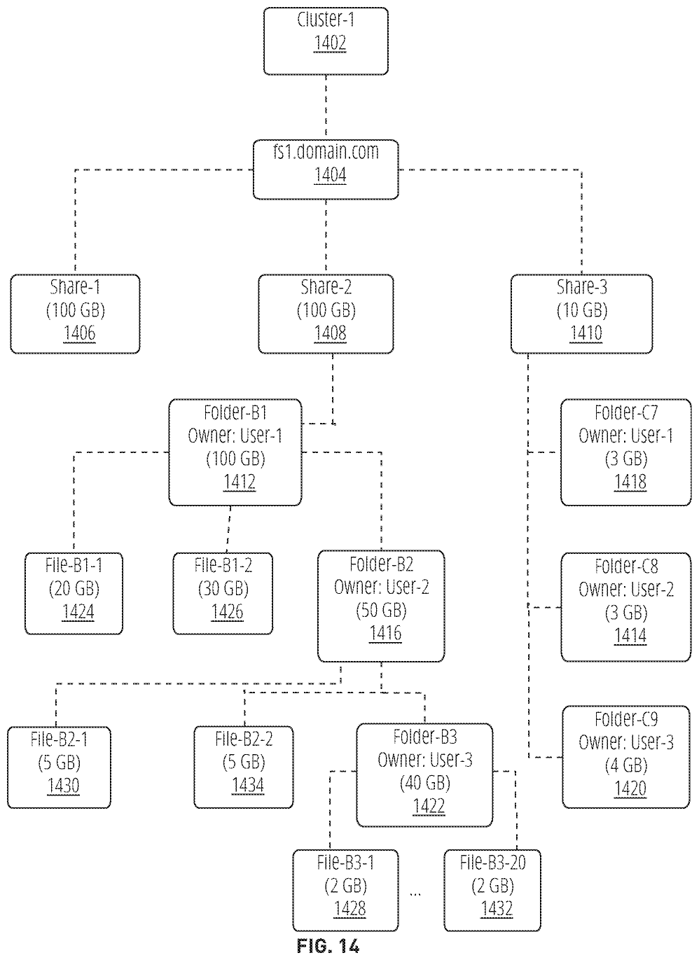

FIGS. 13 and 14 illustrate an example hierarchical namespace of a file server according to particular embodiments. Cluster-1 1302 is a cluster, which may contain one or more file server instances, such as an instance named FS1.domain.com 1304. Although one cluster is shown in FIGS. 13 and 14, there may be multiple clusters, and each cluster may include one or more file server instances. The file server FS1.domain.com 1304 contains three shares: Share-1 1306, Share-2 1308, and Share-3 1310. Share-1 may be a home directory share on which user directories are stored, and Share-2 and Share-3 may be departmental shares for two different departments of a business organization, for example. Each share has an associated size in gigabytes, e.g., 100 GB (gigabytes) for Share-1, 100 GB for Share-2, and 10 GB for Share-3. The sizes may indicate a total capacity, including used and free space, or may indicate used space or free space. Share-1 includes three folders, Folder-A1 1312, Folder-A2 1314, and Folder-A3 1316. The capacity of Folder-A1 is 18 GB, Folder-A2 is 16 GB, and Folder-A3 is 66 GB. Further, each folder is associated with a user, referred to as an owner. Folder-A1 is owned by User-1, Folder-A2 by User-2, and Folder-A3 by User-3. Folder-A1 contains a file named File-A1-1 418, of size 18 Gb. Folder-A2 contains 32 files, each of size 0.5 GB, named File-A2-1 1320 through File-A2-32 1328. Folder-A3 contains 33 files, each of size 2 GB, named File-A3-1 1322 and File-A3-2 1324 through File-A3-33 1326.

FIG. 14 shows the contents of Share-2 1408 and Share-3 1410 of FS1.domain.com 1404. Share-2 contains a folder named Folder-B1 440, owned by User-1 and having a size of 100 Gb. Folder-B1 contains File-B1-1 1424 of size 20 Gb, File-B1-2 1426 of size 30 Gb, and Folder-B2 1416, owned by User-2 and having size 50 Gb. Folder-B2 contains File-B2-1 1430 of size 5 Gb, File-B2-2 1434 of size 5 Gb, and Folder-B3 1422, owned by User-3 and having size 40 Gb. Folder-B3 1422 contains 20 files of size 2 Gb each, named File-B3-1 1428 through File-B3-20 1432. Share-3 contains three folders: Folder-C7 1418 owned by User-1 of size 3 GB, Folder-C8 1414 owned by User-2 of size 3 GB, and Folder-C9 1420 owned by User-3 of size 4 GB.

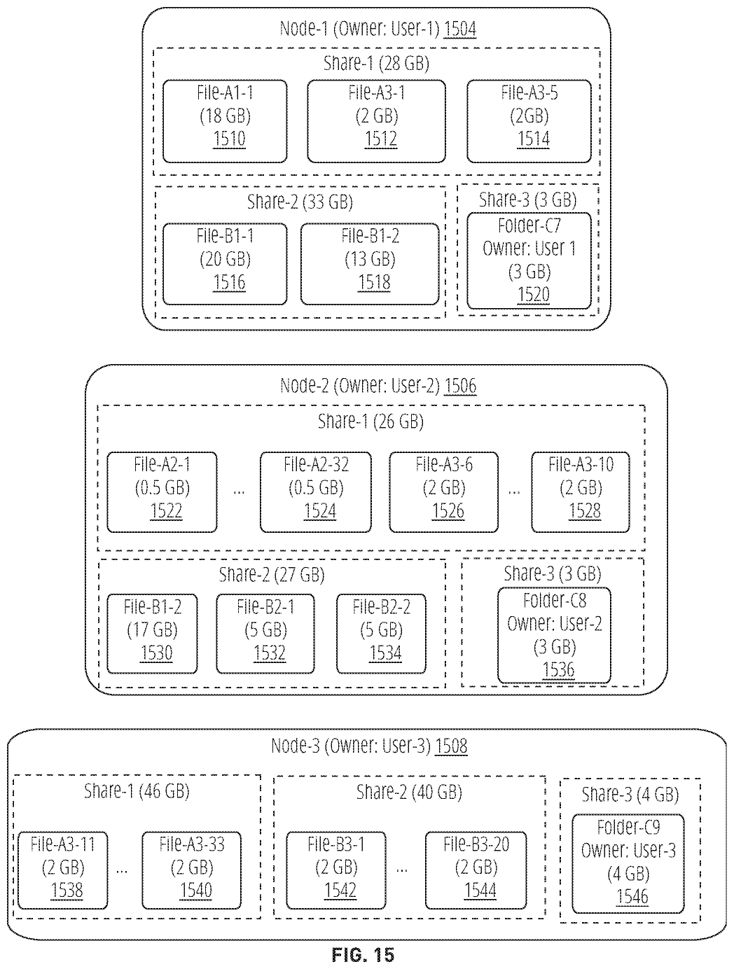

FIG. 15 illustrates distribution of stored data amongst host machines in a virtualized file server according to particular embodiments. In the example of FIG. 15, the three shares are spread across three host machines 1504, 1506, and 1508. Approximately one-third of each share is located on each of the three FSVMs. For example, approximately one-third of Share-3's files are located on each of the three FSVMs. Note that from a user's point of a view, a share looks like a directory. Although the files in the shares (and in directories) are distributed across the three host machines 1504, 1506, and 1508, the VFS provides a directory structure having a single namespace in which client executing on user VMs may access the files in a location-transparent way, e.g., without knowing which host machines store which files (or which blocks of files).

In the example of FIG. 15, Host-1 stores (e.g., is assigned to) 28 Gb of Share-1, including 18 Gb for File-A1-1 1510 and 2 Gb each for File-A3-1 1512 through File-A3-5 1514, 33 Gb of Share-2, including 20 Gb for File-B1-1 and 13 Gb for File-B1-2, and 3 Gb of Share-3, including 3 Gb of Folder-C7. Host-2 stores 26 Gb of Share-1, including 0.5 Gb each of File-A2-1 1522 through File-A2-32 1524 (16 Gb total) and 2 Gb each of File-A3-6 1526 through File-A3-10 1528 (10 Gb total), 27 Gb of Share-2, including 17 Gb of File-B1-2, 5 Gb of File-B2-1, and 5 Gb of File-B2-2, and 3 Gb of Share-3, including 3 Gb of Folder-C8. Host-3 stores 46 GB of Share-1, including 2 GB each of File-A3-11 1538 through File-A3-33 1540 (66 GB total), 40 GB of Share-2, including 2 GB each of File-B3-1 1542 through File-B3-20 1544, and Share-3 stores 4 GB of Share-3, including 4 GB of Folder-C9 1546.

In particular embodiments, a system for managing communication connections in a virtualization environment includes a plurality of host machines implementing a virtualization environment. Each of the host machines includes a hypervisor and at least one user virtual machine (user VM). The system may also include a connection agent, an I/O controller, and/or a virtual disk comprising a plurality of storage devices. The virtual disk may be accessible by all of the I/O controllers, and the I/O controllers may conduct I/O transactions with the virtual disk based on I/O requests received from the user VMs. The I/O requests may be, for example, requests to perform particular storage access operations such as list folders and files in a specified folder, create a new file or folder, open an existing file for reading or writing, read data from or write data to a file, as well as file manipulation operations to rename, delete, copy, or get details, such as metadata, of files or folders. Each I/O request may reference, e.g., identify by name or numeric identifier, a file or folder on which the associated storage access operation is to be performed. The system further includes a virtualized file server, which includes a plurality of FSVMs and associated local storage. Each FSVM and associated local storage device is local to a corresponding one of the host machines. The FSVMs conduct I/O transactions with their associated local storage based on I/O requests received from the user VMs. For each one of the host machines, each of the user VMs on the one of the host machines sends each of its respective I/O requests to a selected one of the FSVMs, which may be selected based on a lookup table, e.g., a sharding map, that maps a file, folder, or other storage resource referenced by the I/O request to the selected one of the FSVMs).

In particular embodiments, the initial FSVM to receive the request from the user VM may be determined by selecting any of the FSVMs on the network, e.g., at random, by round robin selection, or by a load-balancing algorithm, and sending an I/O request to the selected FSVM via the network or via local communication within the host machine. Local communication may be used if the file or folder referenced by the I/O request is local to the selected FSVM, e.g., the referenced file or folder is located on the same host machine as the selected FSVM. In this local case, the I/O request need not be sent via the network. Instead, the I/O request may be sent to the selected FSVM using local communication, e.g., a local communication protocol such as UNIX domain sockets, a loopback communication interface, inter-process communication on the host machine, or the like. The selected FSVM may perform the I/O transaction specified in the I/O request and return the result of the transaction via local communication. If the referenced file or folder is not local to the selected FSVM, then the selected FSVM may return a result indicating that the I/O request cannot be performed because the file or folder is not local to the FSVM. The user VM may then submit a REFERRAL request or the like to the selected FSVM, which may determine which FSVM the referenced file or folder is local to (e.g., by looking up the FSVM in a distributed mapping table), and return the identity of that FSVM to the user VM in a REDIRECT response or the like. Alternatively, the selected FSVM may determine which FSVM the referenced file or folder is local to, and return the identity of that FSVM to the user VM in the first response without the REFERRAL and REDIRECT messages. Other ways of redirecting the user VM to the FSVM of the referenced file are contemplated. For example, the FSVM that is on the same host as the requesting user VM (e.g., local to the requesting user VM) may determine which FSVM the file or folder is local to, and inform the requesting user VM of the identity of that FSVM without communicating with a different host.

In particular embodiments, the file or folder referenced by the I/O request includes a file server name that identifies a virtualized file server on which the file or folder is stored. The file server name may also include or be associated with a share name that identifies a share, file system, partition, or volume on which the file or folder is stored. Each of the user VMs on the host machine may send a host name lookup request, e.g., to a domain name service, that includes the file server name, and may receive one or more network addresses of one or more host machines on which the file or folder is stored.

In particular embodiments, as described above, the FSVM may send the I/O request to a selected one of the FSVMs. The selected one of the FSVMs may be identified by one of the host machine network addresses received above. In one aspect, the file or folder is stored in the local storage of one of the host machines, and the identity of the host machines may be determined as described below.

In particular embodiments, when the file or folder is not located on storage local to the selected FSVM, e.g., when the selected FSVM is not local to the identified host machine, the selected FSVM responds to the I/O request with an indication that the file or folder is not located on the identified host machine. Alternatively, the FSVM may look up the identity of the host machine on which the file or folder is located, and return the identity of the host machine in a response.

In particular embodiments, when the host machine receives a response indicating that the file or folder is not located in the local storage of the selected FSVM, the host machine may send a referral request (referencing the I/O request or the file or folder from the I/O request) to the selected FSVM. When the selected FSVM receives the referral request, the selected FSVM identifies one of the host machines that is associated with a file or folder referenced in the referral request based on an association that maps files to host machines, such as a sharding table (which may be stored by the centralized coordination service). When the selected FSVM is not local to the host machine, then the selected FSVM sends a redirect response that redirects the user VM on the host machine to the machine on which the selected FSVM is located. That is, the redirect response may reference the identified host machine (and by association the selected second one of the FSVMs). In particular embodiments, the user VM on the host machine receives the redirect response and may cache an association between the file or folder referenced in the I/O request and the host machine referenced in the redirect response.

In particular embodiments, the user VM on the host machine may send a host name lookup request that includes the name of the identified host machine to a name service, and may receive the network address of the identified host machine from the name service. The user VM on the host machine may then send the I/O request to the network address received from the name service. The FSVM on the host machine may receive the I/O request and performs the I/O transaction specified therein. That is, when the FSVM is local to the identified host machine, the FSVM performs the I/O transaction based on the I/O request. After performing or requesting the I/O transaction, the FSVM may send a response that includes a result of the I/O transaction back to the requesting host machine. I/O requests from the user VM may be generated by a client library that implements file I/O and is used by client program code (such as an application program).

Particular embodiments may provide dynamic referral type detection and customization of the file share path. When a user VM (e.g., client or one of the user VMs) sends a request for a storage access operation specifying a file share to a FSVM node in the VFS cluster of FSVM nodes, the user VM may be sent a referral to another FSVM node that is assigned to the relevant file share. Certain types of authentication may use either host-based referrals (e.g., Kerberos) or IP-based referrals (e.g., NTLM). In order to flexibly adapt to any referral type, particular embodiments of the FSVMs may detect the referral type in an incoming request and construct a referral response that is based on the referral type and provide the referral. For example, if the user VM sends a request to access a storage item at a specified file share using an IP address, particular embodiments may construct and provide an IP address-based referral; if the user VM sends a request to access the storage item at the specified file share using a hostname, then particular embodiments may construct and provide a hostname-based referral, including adding the entire fully qualified domain name.

For example, if a user VM sends a request for File-A2-1 (which resides on Node-2) to Node-1 using a hostname-based address \\fs1\share-1\File-A2-1, VFS may determine that File-A2-1 actually resides on Node-2 and send back a referral in the same referral type (hostname) as the initial request: \\fs2.domain.com\share-1\File-A2-1. If a user VM sends a request for File-A2-1 to Node-1 using an IP-based address \\198.82.0.23share-1\File-A2-1, after determining that File-A2-1 actually resides on Node-2, VFS may send back a referral in the same referral type (IP) as the initial request: \\198.82.0.43\share-1\File-A2-1.

In particular embodiments, the hostname for the referral node may be stored in a distributed cache in order to construct the referral dynamically using hostname, current domain, and share information.

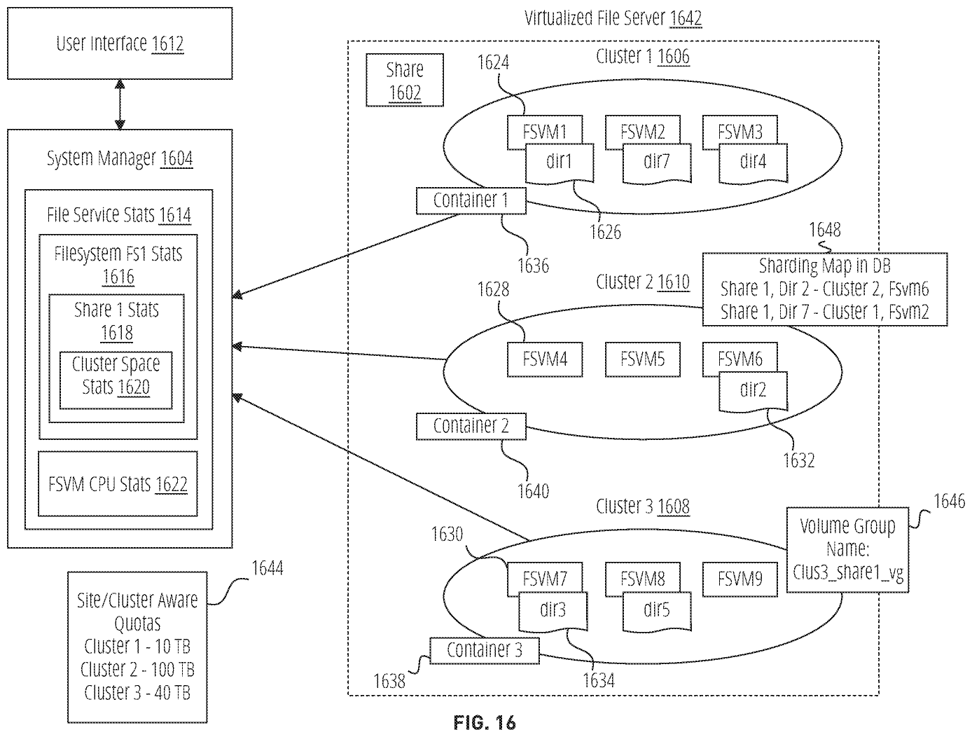

FIG. 16 illustrates an example virtualized file server (VFS) environment in which a VFS 1642 named “FS1” is deployed across multiple clusters 1606, 1608, and 1610 according to particular embodiments. Different clusters may be at different geographic locations, e.g., in different buildings, cities, or countries. Particular embodiments may facilitate deploying and managing a VFS 1642 having networking, compute-unit, and storage resources distributed across multiple clusters from a system management portal or interface such as system manager 1604. The system manager 1604 may be, e.g., a computer program code that can execute on one or more host systems. FIG. 16 also illustrates fault-tolerant inter-cluster sharding of a share “Share 1” across compute units and clusters and cluster/site/location aware quotas within the share 1602.

Particular embodiments may create a VFS 1642 and distribute compute units, which may be FSVMs, to one or more clusters 1606, 1610, 1608. For example, a portal user interface 1612 of the system manager 1604 may be used by a system administrator or user to create the VFS 1642. While creating the VFS 1642, the system administrator or user may be presented with a list of clusters, from which the administered or user may select one or more clusters. The compute units (e.g., FSVMs), networking (IP addresses), and storage (containers 1636, 1640, 1638) may be distributed to the selected clusters. In the example of FIG. 16, the user has chosen three clusters, Cluster 1, Cluster 2, and Cluster 3 from the list. In this example, three FSVMs are created on each cluster and included in the VFS 1642, for a total of 9 FSVMs across the three clusters 1606, 1610, 1608. Each cluster hosts a separate container, which may provide storage services to the FSVMs, e.g., using volume groups (such as volume group 1646) that contain disk devices. Each container may store a portion of the file server data. The containers 1636, 1640, 1638 are labeled Container 1, Container 2, and Container 3 in this example. The containers may be hidden from the administrator or user.

Particular embodiments may create one or more shares and distribute the data stored within the shares across the clusters 1606, 1610, 1608. The data stored within the shares may be distributed to multiple storage units, e.g., containers, and multiple compute units, e.g., FSVMs, which may be distributed across multiple clusters. The portal user interface 1612 may be used to create the “Share1” share 1602 within the VFS 1642. A storage pool of multiple virtual disks (vDisks) is constructed on the FSVMs on the clusters 1606, 1610, 1608. Each storage pool on each FSVM may be responsible for a subset of the data stored in the share 1602. The share 1602 may be sharded at the top-level directories across FSVMs residing in different clusters. For example, different top-level directories may be stored on different clusters, but each sub-directory of another directory is stored on the same cluster as its parent directory.

In a VFS 1642, the processing units (FSVMs) and data storage units (containers 1636, 1640, 1638) may be sharded, e.g., partitioned, across clusters 1606, 1610, 1608 and may further be sharded across host machines within each cluster. Initially, several existing directories, e.g., dir1 1626, dir2 1632, dir3 1634, dir4, and dir5, have been created on Share1 share 1602 of the FS1 VFS 1642. The directories may contain files and other directories (not shown). FSVM1 1624, FSVM2, and FSVM3 are located on Cluster1 1606, FSVM4 1628, FSVM5, and FSVM6 are located on Cluster2 1610, and FSVM7 1630, FSVM8, and FSVM9 are located on Cluster3 1608. Of the directories located on Share1 share 1602, dir1 1626 is located on FSVM1 1624, dir4 is located on FSVM3, dir2 1632 is located on FSVM6, dir3 1634 is located on FSVM7 1630, and dir5 is located on FSVM8. Each FSVM within each cluster hosts a storage pool created from a subset of the storage provided by the cluster's container. A sharding map 1648 is stored in a database and initially contains five entries that specify the locations (e.g., cluster and FSVM) of Share1 's dir1-dir5.

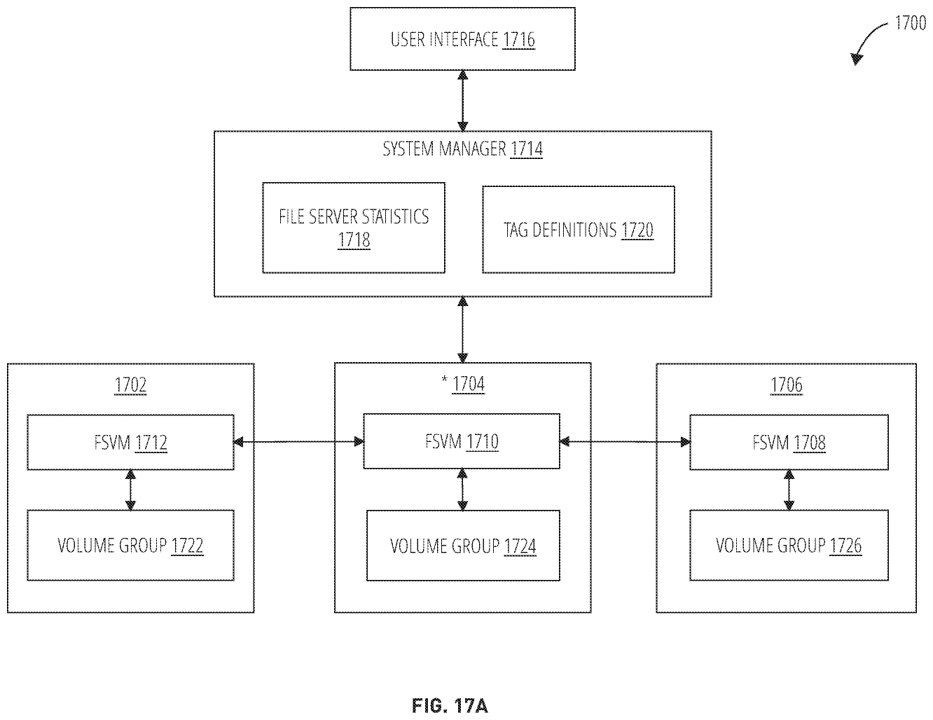

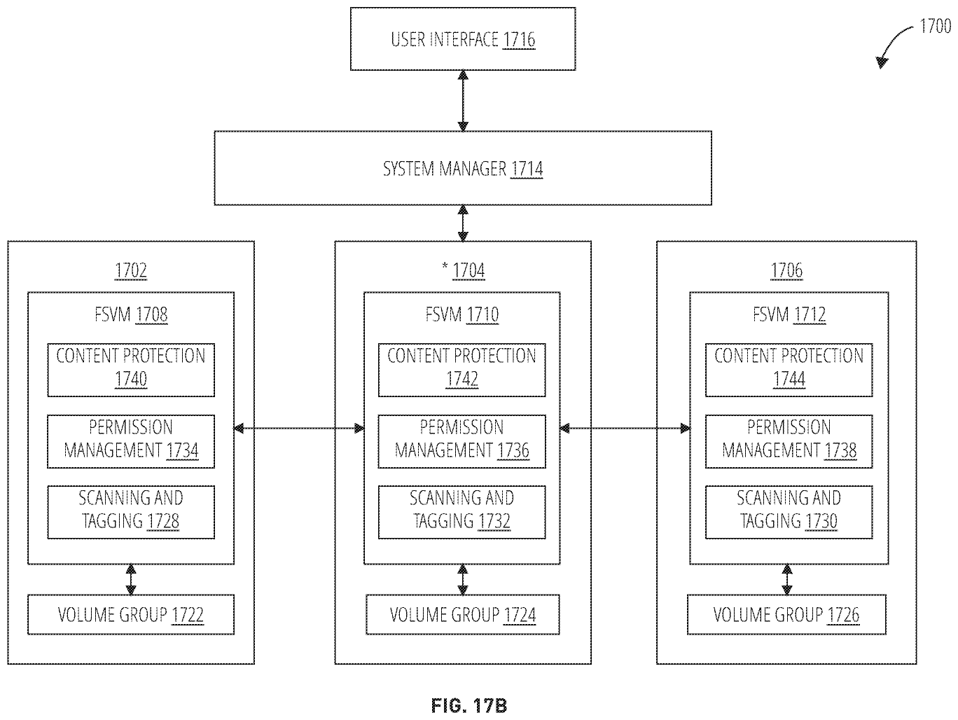

FIG. 17A illustrates an example VFS environment 1700 in accordance with one embodiment. FIG. 17B illustrates the VFS environment 1700. In the example environment shown in FIG. 17A, three computing nodes 1702, 1704, and 1706 each include a FSVM and a volume group, forming a cluster of a VFS. The computing node 1704 acts as the leader node and communicates with a system manager 1714. The system manager 1714 stores tag definitions 1720 and file server statistics 1718 and provides a user interface 1716 for interaction with the VFS. The view shown in FIG. 17B shows the FSVMs 1708, 1710, and 1712 in more detail.

In various embodiments, the nodes 1702, 1704, and 1706 may be host computing devices or nodes within a clusterized computing environment, as described above with respect to FIGS. 1-16. For example, though not shown in FIG. 17A, the nodes 1702, 1704, and 1706 may each include a hypervisor to provide a virtualization environment and user VMs, which may be implemented using any of the techniques and features described with respect to user VMs of FIGS. 1-16. The nodes 1702, 1704, and 1706 may further include controller virtual machines (CVM) to provide access to the volume groups 1722, 1724, and 1726 by the FSVMs 1712, 1710, and 1708, respectively. CVMs may be implemented with techniques and features described with respect to CVMs of FIGS. 1-16.

The system manager 1714 may be implemented using the techniques and features described with respect to the system manager 1604 of FIG. 16. For example, the system manager 1714 may include a system portal or interface and may be implemented as computer program code that can execute on one or more host systems. In some implementations, for example, the system manager 1714 may execute on one or the nodes 1702, 1704, 1706 as a virtual machine. In other implementations, the system manager 1714 may be implemented using another computing device in communication with the VFS.

As shown in FIG. 17A, the system manager 1714 includes file server statistics 1718 and tag definitions 1720. File server statistics 1718 may include, for example, statistics on the amount of storage used, the amount of storage available, location and utilization of various nodes of the VFS, backup policies, and files tagged with various tags across the VFS. Tag definitions 1720 may include pre-defined patterns and/or user defined patterns. For example, tag definitions 1720 may include patterns indicating social security numbers, credit card data, health information, or files pertaining to a particular client or entity. Tag definitions 1720 may also include any policy associated with a particular pattern. For example, a user defined pattern may tag any file including the word “alpha” as part of a sensitive project and an associated policy may restrict access to files with that tag to a particular group or class of users. Accordingly, the tag definitions 1720 may include proposed patterns and policies as well as tracking tags, patterns, and associated policies used within the VFS.

The user interface 1716 may be presented by the system manager 1714 to a display of a computing device to allow an administrative user (or other user with appropriate permissions) to view file server statistics 1718, update and view tag definitions 1720, and perform other tasks related to the VFS.

The FSVMs 1712, 1710, and 1708 may perform any of the functions described above with respect to FSVMs. For example, the FSVMs 1712, 1710, and 1708 may communicate with user VMs to receive requests to access files of the VFS and may provide requested files to the user VMs. Each of the FSVMs 1712, 1710, and 1708 may also store or have access to access control information (e.g., an access control list or information management metadata) for files stored on volume groups managed by the FSVM. In some implementations, the access control information may include groups of users who are allowed to access groups of files or sensitive information within files. The FSVMs 1712, 1710, and 1708 may communicate with each other to manage the files of the VFS, as described above with respect to FIGS. 1-16.

As shown in FIG. 17B, the FSVMs 1708, 1710, and 1712 each include content protection, permission management, and scanning and tagging. For explanation, functionality will be described with respect to the components of the FSVM 1710, though it should be understood that the corresponding components of the FSVM 1708 and the FSVM 1712 may perform the same or similar functions. For example, content protection 1740 and content protection 1744 may operate in the same manner as content protection 1742. Each of content protection 1742, permission management 1736, and scanning and tagging 1732 may be implemented as one or more modules of the executable instructions of the FSVM 1710.

Scanning and tagging 1732 may include functionality for accessing the contents of files on the volume group 1724 and for tagging files on the volume group 1724 based on the scan. For example, scanning and tagging 1732 may include functionality for document conversion, image recognition and conversion, pattern matching, natural language text processing. In some implementations, image recognition and conversion may be implemented by optical character recognition (OCR) functionality to convert images to text that can be analyzed by natural language processors or pattern matching. Natural language text processing may be implemented using machine learning algorithms to perform parsing, topic segmentation, or other functions as useful. Pattern matching may include functionality for identifying both narrow patterns (e.g., the format of a social security number) and broad patterns (e.g., the formatting of a document). In some implementations, scanning and tagging 1732 may tag files scanned files by saving the tag as an extended file attribute of the file. In some implementations, other information, such as an access level for the file, may also be stored as an extended file attribute.

Permission management 1736 may include access control information (e.g., access control lists) for files managed by the FSVM. In some implementations, access control information stored at permission management 1736 may include individual users able to access particular files. Additionally or alternatively, access control information may include classes of users (e.g., administrators, technical users, administrative users) that are able to access the files. Additionally or alternatively, permission management 1736 may include functionality to interpret access information stored as extended file attributes of files managed by the FSVM.

Content protection 1742 may communicate with permission management 1736 and include functionality for redacting, censoring, or otherwise controlling how information is presented to users responsive to a user request. For example, content protection 1742 may include functionality for identifying credit card numbers in a list of client data and redacting credit card numbers when the request to view customer data does not come from a user in a finance department. Content protection 1742 may also include functionality for managing replication and backup policies with regards to groups of tagged files.

In some implementations, the VFS environment 1700 may include multiple clusters including additional FSVMs and computing nodes. Further, nodes 1702, 1704, and 1706 may include additional features not described with respect to FIG. 17A and FIG. 17B, but described above with respect to FIGS. 1-16.

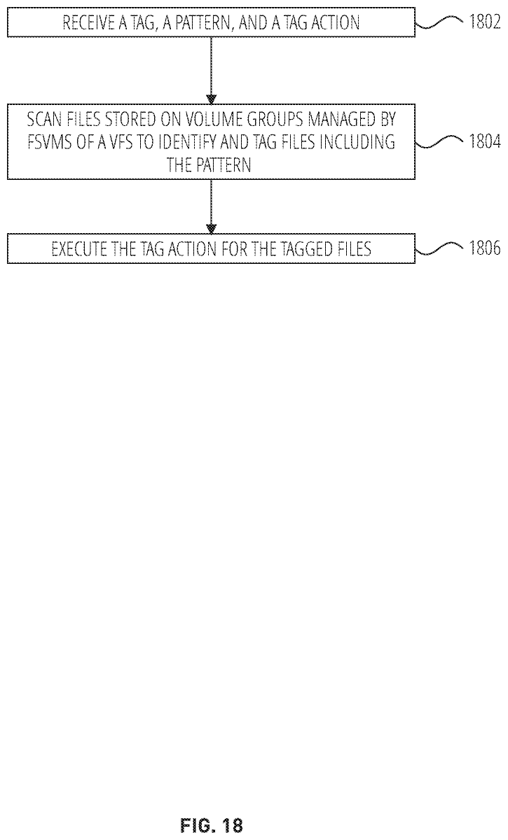

FIG. 18 illustrates an example method for tagging files in a virtualized file server in accordance with one embodiment. At block 1802, a tag, a pattern, and a tag action are received. For example, the tag, pattern, and action may be received at the FSVM 1710 from the system manager 1714. The system manager 1714 may receive the tag, pattern, and action via the user interface 1716. For example, a user may define a tag “social security number” with an associated pattern on numbers formatted as “XX-XX-XXXX.” The associated action may be to update access data such that only a user with human resources permissions will see the actual numbers when viewing a file including a social security number pattern. For other users, the actual numbers may be redacted, replaced with symbols, or otherwise removed from the document for viewing. In another example a user may create a tag “manhattan” for files containing either the phrase manhattan or information pertaining to the subject matter of a highly confidential project. The action associated with the tag may be to replicate and save a backup copy of any files tagged “manhattan” when the file is altered or saved.

In some implementations, the FSVM 1710, as a leader of the cluster, may communicate the tag, pattern, and action to the FSVMs 1712 and 1708. In some implementations, the VFS may include additional clusters of FSVMs and, accordingly, a leader FSVM in the additional clusters may receive the tag, pattern, and definition at block 1802. Further, in some implementations, the tags, patterns, and actions may be received by the FSVMs in another manner (e.g., as preprogrammed settings).

At block 1804, FSVMs of a VFS scan files managed by the FSVMs to identify and tag files including the pattern. In some implementations, FSVMs may be instructed to scan files immediately upon receipt of the tag, pattern, and action. In other implementations, FSVMs may scan files at regular intervals or responsive to a defined event. For example, the FSVMs may be instructed to scan files stored on volume groups managed by the FSVM hourly, daily, or weekly. FSVMs may also scan files, for example, responsive to updates to the file or creation of a new file. In some implementations, scanning may be both interval based and event based.

At block 1804, an FSVM generally scans files stored on volume groups associated with the FSVM. For example, FSVM 1710 may scan files stored at volume group 1724. The scanning of block 1804 may take place using functionality at scanning and tagging 1732. In some implementations, scanning may include conversion of some files to a text-based format for pattern recognition. In other implementations, scanning and tagging 1732 may include functionality for pattern recognition for both text based and image based files. When a file includes the pattern the FSVM is scanning for, the FSVM tags the file with the corresponding tag. In some implementations, the FSVM adds the tag as an extended file attribute. In some implementations, an FSVM may scan files and look for several patterns while scanning the files.

At block 1806, the tag action is executed for the tagged files. Depending on the tag action, block 1806 may occur directly after an object is tagged or may happen at another time. For example, files related to a project may be scanned and tagged on creation, but replicated at a backup storage location every 24 hours. In some implementations, the tag action may include several actions that occur at different times. For example, an FSVM may update access data for a file stores at permission management 1736 as soon as a file is tagged. The FSVM may then alter content of the file at content protection 1742 responsive to a request from a user to access the file. In some implementations, the tag action may include implementing an access schedule for the file. For example, access data for a file may be updated such that the file is accessible at certain times and inaccessible at others. Access schedules may apply to individual users or may be universal for the file.

In some implementations, the action may include replicating files in a share including a tag and not replicating other files in the share including the tag. In these implementations, the received action may include additional parameters, including a location for the replicated files. In some implementations, the replicated files may be stored at another location within the VFS (e.g., at a different cluster at another physical location). In other implementations, the replicated files may be stored outside of the VFS (e.g., at a cloud storage location). To replicate all files with a tag across a share cooperatively managed by a plurality of FSVMs, each of the FSVMs may replicate files stored at a location (e.g., a volume group) managed by the FSVM.

In various implementations, additional operations may be included in the method. Further, while the method is described with respect to the FSVM 1710, other FSVMs (e.g., FSVM 1708 and FSVM 1712) may perform the operations of the method concurrently or at different times. Further, in some implementations, additional FSVMs may be included in additional clusters of the VFS and may perform some or all of the operations of the method.

Because actions may be tag-based (e.g., an FSVM takes an action based on tagged items) instead of folder, directory, or share based (e.g, an FSVM takes an action for a specific grouping of files), users are not required to store files in a common directory based on, for example, project or security level. Accordingly, security and backup policies (such as redaction of sensitive information or backup of high priority files) are more effective and less likely to miss some items, such as sensitive information inadvertently stored in the incorrect directory.

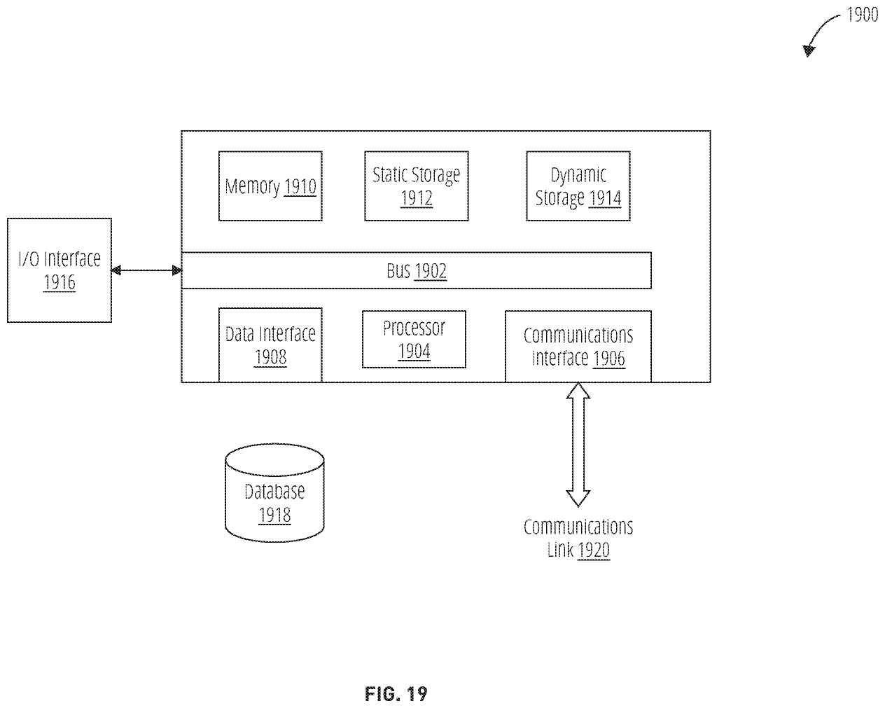

FIG. 19 is a block diagram of an illustrative computing system 1900 suitable for implementing particular embodiments. For example, nodes 1702, 1704, and 1706 may be implemented by a computing system 1900. In particular embodiments, one or more computer systems 1900 perform one or more steps of one or more methods described or illustrated herein. In particular embodiments, one or more computer systems 1900 provide functionality described or illustrated herein. In particular embodiments, software running on one or more computer systems 1900 performs one or more steps of one or more methods described or illustrated herein or provides functionality described or illustrated herein. Particular embodiments include one or more portions of one or more computer systems 1900. Herein, reference to a computer system may encompass a computing device, and vice versa, where appropriate. Moreover, reference to a computer system may encompass one or more computer systems, where appropriate.

This disclosure contemplates any suitable number of computer systems 1900. This disclosure contemplates computing system 1900 taking any suitable physical form. As example and not by way of limitation, computing system 1900 may be an embedded computer system, a system-on-chip (SOC), a single-board computer system (SBC) (such as, for example, a computer-on-module (COM) or system-on-module (SOM)), a desktop computer system, a mainframe, a mesh of computer systems, a server, a laptop or notebook computer system, a tablet computer system, or a combination of two or more of these. Where appropriate, computing system 1900 may include one or more computer systems 1900; be unitary or distributed; span multiple locations; span multiple machines; span multiple data centers; or reside in a cloud, which may include one or more cloud components in one or more networks. Where appropriate, one or more computer systems 1900 may perform without substantial spatial or temporal limitation one or more steps of one or more methods described or illustrated herein. As an example and not by way of limitation, one or more computer systems 1900 may perform in real time or in batch mode one or more steps of one or more methods described or illustrated herein. One or more computer systems 1900 may perform at different times or at different locations one or more steps of one or more methods described or illustrated herein, where appropriate.

Computing system 1900 includes a bus 1902 (e.g., an address bus and a data bus) or other communication mechanism for communicating information, which interconnects subsystems and devices, such as processor 1904, memory 1910 (e.g., RAM), static storage 1912 (e.g., ROM), dynamic storage 1914 (e.g., magnetic or optical), communications interface 1906 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 1916 (e.g., keyboard, keypad, mouse, microphone). In particular embodiments, computing system 1900 may include one or more of any such components.

In particular embodiments, processor 1904 includes hardware for executing instructions, such as those making up a computer program. As an example and not by way of limitation, to execute instructions, processor 1904 may retrieve (or fetch) the instructions from an internal register, an internal cache, memory 1910, static storage 1912, or dynamic storage 1914; decode and execute them; and then write one or more results to an internal register, an internal cache, memory 1910, static storage 1912, or dynamic storage 1914. In particular embodiments, processor 1904 may include one or more internal caches for data, instructions, or addresses. This disclosure contemplates processor 1904 including any suitable number of any suitable internal caches, where appropriate. As an example and not by way of limitation, processor 1904 may include one or more instruction caches, one or more data caches, and one or more translation lookaside buffers (TLBs). Instructions in the instruction caches may be copies of instructions in memory 1910, static storage 1912, or dynamic storage 1914, and the instruction caches may speed up retrieval of those instructions by processor 1904. Data in the data caches may be copies of data in memory 1910, static storage 1912, or dynamic storage 1914 for instructions executing at processor 1904 to operate on; the results of previous instructions executed at processor 1904 for access by subsequent instructions executing at processor 1904 or for writing to memory 1910, static storage 1912, or dynamic storage 1914; or other suitable data. The data caches may speed up read or write operations by processor 1904. The TLBs may speed up virtual-address translation for processor 1904. In particular embodiments, processor 1904 may include one or more internal registers for data, instructions, or addresses. This disclosure contemplates processor 1904 including any suitable number of any suitable internal registers, where appropriate. Where appropriate, processor 1904 may include one or more arithmetic logic units (ALUs); be a multi-core processor; or include one or more processors. Although this disclosure describes and illustrates a particular processor, this disclosure contemplates any suitable processor.

In particular embodiments, I/O interface 1916 includes hardware, software, or both, providing one or more interfaces for communication between computing system 1900 and one or more I/O devices. Computing system 1900 may include one or more of these I/O devices, where appropriate. One or more of these I/O devices may enable communication between a person and computing system 1900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1916 for them. Where appropriate, I/O interface 1916 may include one or more device or software drivers enabling processor 1904 to drive one or more of these I/O devices. I/O interface 1916 may include one or more I/O interfaces 1916, where appropriate. Although this disclosure describes and illustrates a particular I/O interface, this disclosure contemplates any suitable I/O interface.

In particular embodiments, communications interface 1906 includes hardware, software, or both providing one or more interfaces for communication (such as, for example, packet-based communication) between computing system 1900 and one or more other computer systems or one or more networks. As an example and not by way of limitation, communications interface 1906 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1906 for it. As an example and not by way of limitation, computing system 1900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computing system 1900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computing system 1900 may include any suitable communications interface 1906 for any of these networks, where appropriate. Communications interface 1906 may include one or more communication interfaces 1906, where appropriate. Although this disclosure describes and illustrates a particular communication interface, this disclosure contemplates any suitable communication interface.

One or more memory buses (which may each include an address bus and a data bus) may couple processor 1904 to memory 1910. Bus 1902 may include one or more memory buses, as described below. In particular embodiments, one or more memory management units (MMUs) reside between processor 1904 and memory 1910 and facilitate accesses to memory 1910 requested by processor 1904. In particular embodiments, memory 1910 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1910 may include one or more memories, where appropriate. Although this disclosure describes and illustrates particular memory, this disclosure contemplates any suitable memory.

Where appropriate, the ROM may be mask-programmed ROM, programmable ROM (PROM), erasable PROM (EPROM), electrically erasable PROM (EEPROM), electrically alterable ROM (EAROM), or flash memory or a combination of two or more of these. In particular embodiments, dynamic storage 1914 may include a hard disk drive (HDD), a floppy disk drive, flash memory, an optical disc, a magneto-optical disc, magnetic tape, or a Universal Serial Bus (USB) drive or a combination of two or more of these. Dynamic storage 1914 may include removable or non-removable (or fixed) media, where appropriate. Dynamic storage 1914 may be internal or external to computing system 1900, where appropriate. This disclosure contemplates mass dynamic storage 1914 taking any suitable physical form. Dynamic storage 1914 may include one or more storage control units facilitating communication between processor 1904 and dynamic storage 1914, where appropriate.

In particular embodiments, bus 1902 includes hardware, software, or both coupling components of computing system 1900 to each other. As an example and not by way of limitation, bus 1902 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1902 may include one or more buses, where appropriate. Although this disclosure describes and illustrates a particular bus, this disclosure contemplates any suitable bus or interconnect.

According to particular embodiments, computing system 1900 performs specific operations by processor 1904 executing one or more sequences of one or more instructions contained in memory 1910. Such instructions may be read into memory 1910 from another computer readable/usable medium, such as static storage 1912 or dynamic storage 1914. In alternative embodiments, hard-wired circuitry may be used in place of or in combination with software instructions. Thus, particular embodiments are not limited to any specific combination of hardware circuitry and/or software. In one embodiment, the term “logic” shall mean any combination of software or hardware that is used to implement all or part of particular embodiments disclosed herein.

The term “computer readable medium” or “computer usable medium” as used herein refers to any medium that participates in providing instructions to processor 1904 for execution. Such a medium may take many forms, including but not limited to, nonvolatile media and volatile media. Non-volatile media includes, for example, optical or magnetic disks, such as static storage 1912 or dynamic storage 1914. Volatile media includes dynamic memory, such as memory 1910.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In particular embodiments, execution of the sequences of instructions is performed by a single computing system 1900. According to other particular embodiments, two or more computer systems 1900 coupled by communications link 1920 (e.g., LAN, PTSN, or wireless network) may perform the sequence of instructions in coordination with one another.

Computing system 1900 may transmit and receive messages, data, and instructions, including program, i.e., application code, through communications link 1920 and communications interface 1906. Received program code may be executed by processor 1904 as it is received, and/or stored in static storage 1912 or dynamic storage 1914, or other non-volatile storage for later execution. A database 1918 may be used to store data accessible by the computing system 1900 by way of data interface 1908.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. One or more non-transitory computer readable media encoded with instructions which, when executed by one or more processors of a computing node, cause the computing node to:
provide a file server virtual machine (FSVM) configured to participate in a cluster of FSVMs configured to cooperatively manage a distributed virtualized file system (VFS); and
take a specified action on a file stored on a volume group managed by the FSVM, based on a tag indicative of a pattern included in the file.

2. The one or more non-transitory computer readable media of claim 1, wherein the instructions further cause the computing node to:
scan, responsive to receipt of the tag and the pattern from a system manager, files stored on the volume group managed by the FSVM to identify files including the pattern.

3. The one or more non-transitory computer readable media of claim 2, wherein the instructions further cause the computing node to:
tag, by the FSVM, files stored on the volume group managed by the FSVM including the pattern by storing the tag as an extended file attribute of the file.

4. The one or more non-transitory computer readable media of claim 1, wherein the instructions, when executed, cause the computing node to update, at the FSVM, access credentials for the file.

5. The one or more non-transitory computer readable media of claim 1, wherein the instructions further cause the computing node to:
update, at the FSVM, access information for the tagged files based on the specified action.

6. The one or more non-transitory computer readable media of claim 1, wherein the instructions, when executed, cause the computing node to replicate the file.

7. The one or more non-transitory computer readable media of claim 1, wherein the instructions, when executed, cause the computing node to take the specified action on the file based on a tag indicative of a formatting pattern of text within the file.

8. The one or more non-transitory computer readable media of claim 1, wherein the instructions further cause the computing node to:
responsive to a request from a user to access the file, reformat contents of the file based on a comparison between access credentials of the user and the tag.

9. The one or more non-transitory computer readable media of claim 1, wherein taking the specified action for the tagged files comprises creating copies of the tagged files and sending the copies of the tagged files to a backup storage location.

10. The one or more non-transitory computer readable media of claim 1, wherein the instructions further cause the computing node to:
present, via a user interface, information regarding tagged files stored on the volume group managed by the FSVM.

11. A system comprising:
a plurality of file server virtual machines (FSVMs) executing at two or more computing nodes configured to cooperatively manage a distributed virtualized file system (VFS);
a system manager configured to provide a tag based on a pattern and an action associated with the tag to the plurality of FSVMs; and
wherein the plurality of FSVMs are further configured to:
scan files of the VFS to tag files including the pattern and tag, and
take the action with respect to files in the VFS having the tag.

12. The system of claim 11, wherein the plurality of FSVMs include at least a first two FSVMs forming a first cluster of the VFS and at least a second two FSVMs forming a second cluster of the VFS.

13. The system of claim 12, wherein the system manager is further configured to communicate the tag to an FSVM of the first cluster and an FSVM of the second cluster.

14. The system of claim 11, wherein the plurality of FSVMs comprise permission management information for the files of the VFS, wherein the plurality of FSVMs are further configured to update the permission management information for the tagged files based on the action.

15. The system of claim 11, wherein the plurality of FSVMs are further configured to receive requests from user virtual machines to access the files stored on the VFS.

16. The system of claim 15, wherein the plurality of FSVMs are further configured to:
responsive to receipt of a request from a user virtual machine to access a tagged file of the files stored on the VFS, access permission management information for the tagged file; and
alter content of the file before fulfilling the request to access the file based on an identity of the user virtual machine and the permission management information for the tagged file.

17. One or more non-transitory computer readable media encoded with instructions which, when executed by one or more processors of a virtualized file system (VFS), cause the VFS to:
identify, at a plurality of file server virtual machines (FSVMs) of the VFS, files stored in a share cooperatively managed by the plurality of FSVMs including a pattern received from a system manager associated with the VFS;
tag the identified files including the pattern; and
replicate, in accordance with a replication instruction received from the system manager, the tagged files of the share without replicating one or more files in the share not including the pattern.

18. The one or more non-transitory computer readable media of claim 17, wherein the pattern is a user-defined text pattern.

19. The one or more non-transitory computer readable media of claim 17, wherein identifying the files including the pattern comprises converting the files stored on the share managed by the plurality of FSVMs to a common file format.

20. The one or more non-transitory computer readable media of claim 17, wherein the instructions further cause the VFS to:
evaluate, responsive to a request to store a file on the share managed by the FSVM, the file according to the pattern.

21. The one or more non-transitory computer readable media of claim 20, wherein the instructions further cause the VFS to:
tag the file responsive to a determination that the file includes the pattern.

22. The one or more non-transitory computer readable media of claim 17, wherein the instructions further cause the VFS to:
replicate a tagged file of the tagged files in accordance with the replication instruction responsive to an update to the tagged file.
